(19) United States
(12) Patent Application Publication
(10) Pub. No.: US 2013/0287304 A1
(43) Pub. Date: Oct. 31, 2013

(54) IMAGE PROCESSING DEVICE, IMAGE PROCESSING METHOD, AND PROGRAM

(71) Applicant: SONY CORPORATION, Tokyo (JP)

(72) Inventor: Atsushi Kimura, Tokyo (JP)

(73) Assignee: SONY CORPORATION, Tokyo (JP)

(21) Appl. No.: 13/864,451

(22) Filed: Apr. 17, 2013

(30) Foreign Application Priority Data
Apr. 26, 2012 (JP) 2012-100620

(51) Int. Cl. G06T 7/00

(52) U.S. Cl. CPC G06T 7/0028
USPC 382/199

(57) ABSTRACT

There is provided an image processing device, including a seam reference determination processing unit that determines a seam reference to serve as a reference line for determining a seam between adjacent two pieces of frame image data of a series of n pieces (n is a natural number equal to or greater than 2) of frame image data to be used for panoramic image generation using object information of the adjacent two pieces of frame image data, and a seam determination processing unit that determines a seam between the adjacent two pieces of frame image data only within a determining region that is set based on the seam reference determined by the seam reference determination processing unit using the object information.

### BACKGROUND

The present disclosure relates to an image processing device and an image processing method for generating a panoramic image and to a program for realizing the image processing device and the image processing method.

As described in Japanese Patent Laid-Open No. 2010-161520 (US 2010/0171810 A1), image processing to generate a single panoramic image from a plurality of images is known.

For example, a user captures a plurality of images (frame image data) while sweeping a camera horizontally, and, these images are combined to obtain a so-called panoramic image.

Here, “to sweep” refers to an operation to change an image capturing direction through a rotational motion of an image capturing apparatus when capturing images in order to obtain a plurality of frame image data for generating a panoramic image. For example, when the image capturing direction is changed along the horizontal direction, the sweep direction is the horizontal direction.

### SUMMARY

When a panoramic image is generated, a seam between adjacent captured images is determined to combine the images.

In a case where a seam is determined to combine images, there exists the following problem.

In processing to generate a panoramic image by combining a plurality of captured images (a plurality of frame image data), if a moving object is present within a scene to be captured, a part of the moving object is split or blurred, which causes a failure of the image and a deterioration in the image quality.

Thus, from the past, a method has been proposed in which, after having detected a moving object, a seam for forming a panoramic image is determined so as to avoid the moving object.

In a method described in “Image mosaic generation method for generating panoramic image” from “Kensho Iiyoshi and Wataru Mihashi, Image mosaic generation method for generating panoramic image, Image Lab, Japan Industrial Publishing Co., Ltd (2008, June),” a method that uses a solution to a shortest path problem in a graph theory is proposed as a method for determining a seam to combine the images. In this method, a seam of the lowest cost is calculated from a cost value that has been calculated in an overlapping region of two adjacent frames. A high cost is set in a moving object and a low cost is set in a still object to generate a graph, and a seam of the lowest cost is determined. Thus, it is possible to determine a seam having a given shape with high precision that does not split the moving object.

However, a processing load for determining a seam is high, and sufficient resources such as increased computing power and memory capacity may be required.

Meanwhile, in Japanese Patent Laid-Open No. 2009-268037 (US 2009/0290013 A1), memory required to hold object information is reduced, as compared to the past, by projecting two-dimensional object information (pixel value, moving object detection, face detection, body detection, and so on) on a one-dimensional sweep axis. In addition, a method is proposed in which a connecting line (a straight line) between frames is determined in a direction perpendicular to the sweep axis so as not to split the moving object, to thereby suppress a risk of splitting the moving object in a panoramic image and blurring of the moving object caused by superimposition, with processing of lower computational complexity in comparison to a two-dimensional search.

Further, in this method, such disadvantages that constraints for preventing a plurality of seams from intersecting with one another become complicated and that the calculation cost increases are also solved.

However, in this method, since a seam is limited to a straight line that is perpendicular to the sweep direction, flexibility in a seam search is low, and in many cases a seam that does not split the moving object is not found.

According to an embodiment of the present disclosure, in generating a panoramic image, a seam with a high degree of flexibility can be set without increasing a processing load in view of the disadvantages described-above.

According to an embodiment of the present disclosure, there is provided an image processing device including a seam reference determination processing unit that determines a seam reference to serve as a reference line for determining a seam between adjacent two pieces of frame image data of a series of n pieces (n is a natural number equal to or greater than 2) of frame image data to be used for panoramic image generation using object information of the adjacent two pieces of frame image data, and a seam determination processing unit that determines a seam between the adjacent two pieces of frame image data only within a determining region that is set based on the seam reference determined by the seam reference determination processing unit using the object information.

According to an embodiment of the present disclosure, there is provided an image processing method including seam reference determination processing that determines a seam reference to serve as a reference line for determining a seam between adjacent two pieces of frame image data of a series of n pieces (n is a natural number equal to or greater than 2) of frame image data to be used for panoramic image generation using object information of the adjacent two pieces of frame image data, and seam determination processing that determines a seam between the adjacent two pieces of frame image data only within a determining region that is set based on the seam reference determined in the seam reference determination processing using the object information.

According to an embodiment of the present disclosure, there is provided a program to cause an arithmetic processing device to execute the above processing.

According to these technologies of the present disclosure, in order to determine a seam for combining two pieces of frame image data, first, a reference line to serve as a seam reference is determined. Then, a determining region is set based on the seam reference. For example, the seam reference may be a line for roughly selecting a section where a moving object is not present or the like. Then, the determining region may be a region where, for example, the seam reference serves as a center line. This determining region is a part of a region of a maximum range where the two pieces of frame image data overlap with each other, that is, where a seam can be searched for. Then, a seam is determined based on object information only within the determining region. By limiting to only within the determining region, even if, for example, a seam in a line of an indeterminate shape is searched for through a two-dimensional cost function calculation or the like, a processing load is not excessively increased, and an efficient search becomes possible.

According to the technologies of the present disclosure, in generating a panoramic image, it becomes possible to set a seam with high precision and with a high degree of flexibility without increasing a processing load by reducing the memory capacity and the calculation cost. As a result, a high-quality panoramic image can be realized with high-speed processing.

### BRIEF DESCRIPTION OF THE DRAWINGS

FIG. 1 is a block diagram of an image capturing apparatus according to an embodiment of the present disclosure;

FIG. 2 is a descriptive diagram of a group of images obtained in panoramic image capturing;

FIG. 3 is a descriptive diagram of a seam in frame image data in panoramic image capturing;

FIG. 4 is a descriptive diagram of a panoramic image;

FIG. 5 is a descriptive diagram of an image processing device that carries out panoramic combining processing according to the embodiment;

FIG. 6 is a descriptive diagram of a cost function according to the embodiment;

FIG. 7 is a descriptive diagram of reflecting a spatial condition on a cost function according to the embodiment;

FIG. 8 is a descriptive diagram of a relationship of a cost function between frames according to the embodiment;

FIG. 9 is a descriptive diagram of a seam reference and a determining region according to the embodiment;

FIG. 10 is a descriptive diagram of a seam determined according to the embodiment;

FIG. 11 is a descriptive diagram of a two-dimensional search according to the embodiment;

FIG. 12 is a descriptive diagram of blend processing according to the embodiment;

FIG. 13 is a descriptive diagram of an example of variably setting a determining region according to the embodiment;

FIG. 14 is a descriptive diagram of an example of asymmetrically setting a determining region according to the embodiment;

FIG. 15 is a descriptive diagram of another example of image processing according to the embodiment;

FIG. 16 is a flowchart of a panoramic combining processing example I according to the embodiment;

FIG. 17 is a flowchart of a panoramic combining processing example II according to the embodiment;

FIG. 18 is a descriptive diagram of determining a seam reference in an input process according to the embodiment;

FIG. 19 is a descriptive diagram of a storing region after a seam reference is determined according to the embodiment;

FIG. 20 is a flowchart of a panoramic combining processing example III according to the embodiment; and

FIG. 21 is a block diagram of a computing device according to the embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

It should be understood by those skilled in the art that various modifications, combinations, sub-combinations and alterations may occur depending on design requirements and other factors insofar as they are within the scope of the appended claims or the equivalents thereof.

Hereinafter, an embodiment will be described in the following order. Note that, in the embodiment, an image capturing apparatus that includes an image processing device of an embodiment of the present disclosure will be illustrated as an example.

### <1. Configuration of Image Capturing Apparatus>

### <2. Overview of Panoramic Combining Function>

### <3. Panoramic Combining Algorithm of Embodiment>

### <4. Setting Example of Determining Region>

### <5. Use of Low Resolution Image/High Resolution Image>

### <6. Panoramic Combining Processing Example I>

### <7. Panoramic Combining Processing Example II>

### <8. Panoramic Combining Processing Example III>

### <9. Application to Program and Computing Device>

### <10. Modification>

### <1. Configuration of Image Capturing Apparatus>

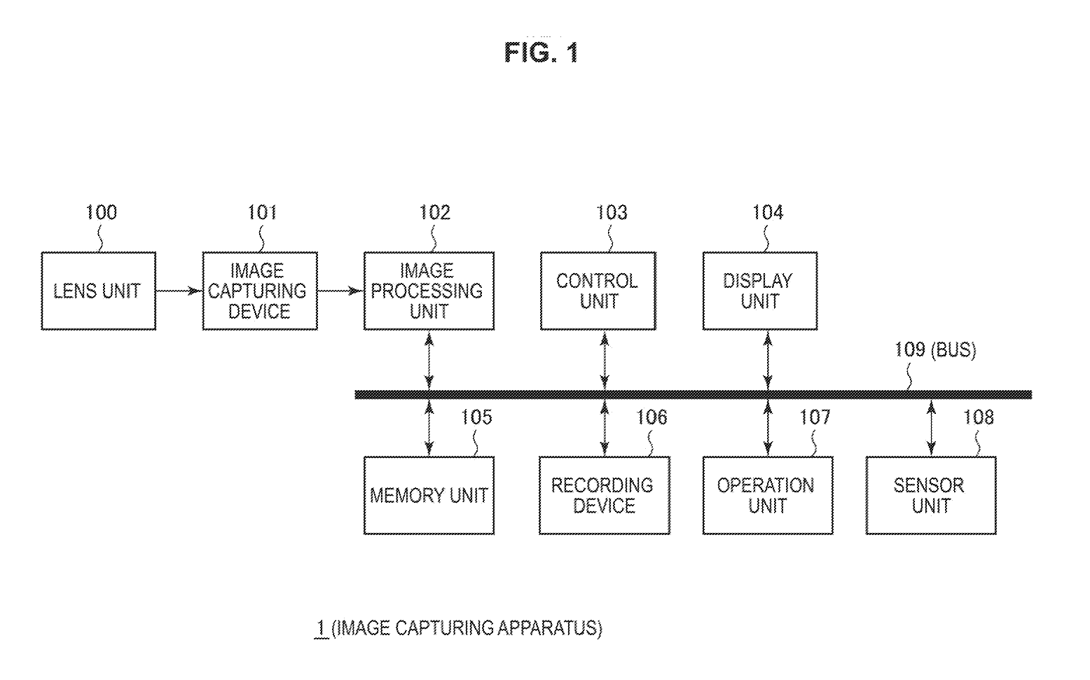

FIG. 1 shows a configuration example of an image capturing apparatus 1 that includes an image processing device of an embodiment of the present disclosure.

The image capturing apparatus 1 includes a lens unit 100, an image capturing device 101, an image processing unit 102, a control unit 103, a display unit 104, a memory unit 105, a recording device 106, an operation unit 107, and a sensor unit 108.

The lens unit 100 collects an optical image of an object. The lens unit 100 has a mechanism for adjusting a focal distance, an object distance, a diaphragm, and so on in accordance with an instruction from the control unit 103 so that an appropriate image can be obtained.

The image capturing device 101 carries out photoelectric conversion to convert the optical image collected by the lens unit 100 into an electric signal. Specifically, the image capturing device 101 is realized by a CCD (Charge Coupled Device) image sensor, a CMOS (Complementary Metal Oxide Semiconductor) image sensor, or the like.

The image processing unit 102 is configured of a sampling circuit that samples the electric signal from the image capturing device 101, an A/D conversion circuit that converts an analog signal into a digital signal, an image processing circuit that carries out predetermined image processing on the digital signal, and so forth. Here, the image processing unit 102 is shown to carry out processing to obtain frame image data through image capturing by the image capturing device 101 and also processing to combine into a panoramic image, which will be described later.

The image processing unit 102 includes not only a dedicated hardware circuit but also a CPU (Central Processing Unit) and a DSP (Digital Signal Processor) and is capable of software processing to respond to flexible image processing.

The control unit 103 is configured of a CPU and a control program and controls each unit of the image capturing apparatus 1. The control program itself is actually stored in the memory unit 105 and executed by the CPU.

Processing to combine into a panoramic image in the present embodiment (panoramic combining processing I, II, III, and the like to be described later) is carried out by the control unit 103 and the image processing unit 102. Details of the processing will be described later.

The display unit 104 is configured of a D/A conversion circuit that converts image data which has been processed by the image processing unit 102 and which is stored in the memory unit 105 into analog data, a video encoder that encodes the analog image signal into a video signal of a format that is suitable for a display device in a later stage, and the display device that displays an image corresponding to an inputted video signal.

The display device is realized, for example, by an LCD (Liquid Crystal Display), an organic EL (Electroluminescence) panel, or the like and also has a function as a finder.

The memory unit 105 is configured of a semiconductor memory such as a DRAM (Dynamic Random Access Memory), and image data processed by the image processing unit 102, the control program in the control unit 103, various data, and so forth are temporarily recorded in the memory unit 105.

The recording device 106 is configured of a recording medium such as a semiconductor memory such as a flash memory, a magnetic disk, an optical disk, and a magnet optical disk, and a record-playback system circuit/mechanism for the recording medium.

At image capturing by the image capturing apparatus 1, the recording device 106 records, in the recording medium, JPEG (Joint Photographic Experts Group) image data that has been encoded into a JPEG format by the image processing unit 102 and that has been stored in the memory unit 105.

At playback, the JPEG image data stored in a recording medium is loaded onto the memory unit 105, and decoding processing is carried out thereon by the image processing unit 102. The decoded image data can be displayed in the display unit 104 or can be outputted to an external device through an external interface (not shown).

The operation unit 107 includes a hardware key such as a shutter button and an input device such as an operation dial and a touch panel. The operation unit 107 detects an input operation by a photographer (user) and communicates to the control unit 103. The control unit 103 determines an operation of the image capturing apparatus 1 in accordance with the input operation by the user and controls each unit to carry out an appropriate operation.

The sensor unit 108 is configured of a gyro sensor, an acceleration sensor, a magnetic field sensor, a GPS (Global Positioning System) sensor, and so forth and detects various pieces of information. These pieces of information are added to the captured image data as metadata and also used for various image processing and control processing.

The image processing unit 102, the control unit 103, the display unit 104, the memory unit 105, the recording device 106, the operation unit 107, and the sensor unit 108 are connected to one another through a bus 109 and exchange image data, a control signal, and so forth with one another.

### <2. Overview of Panoramic Combining Function>

Subsequently, an overview of a panoramic combining function included in the image capturing apparatus 1 will be described.

The image capturing apparatus 1 of the present embodiment can generate a panoramic image by carrying out combining processing on a plurality of still images (frame image data) that is obtained as a photographer captures the images while rotationally moving the image capturing apparatus 1 about a rotational axis.

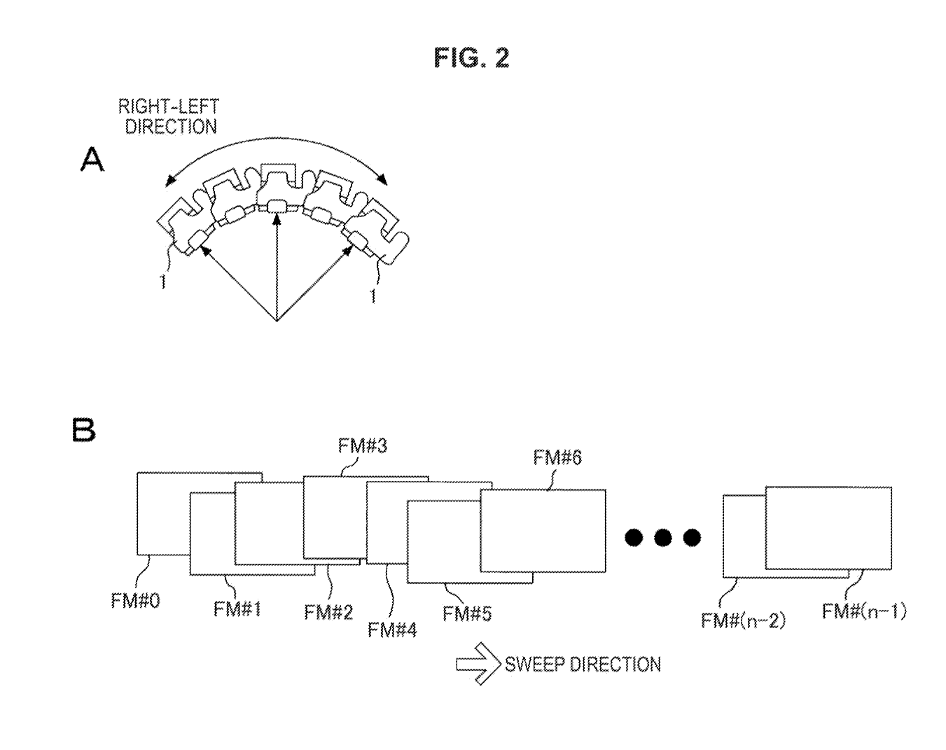

FIG. 2A shows a movement of the image capturing apparatus 1 at panoramic image capturing. At panoramic image capturing, it is desirable that the center of rotation while capturing images lies at a point called a nodal point that is unique to a lens and that does not cause parallax, so that parallax between a distance view and a short-range view does not cause unnaturalness in the seam when images are combined.

The rotational motion of the image capturing apparatus 1 at panoramic image capturing is called to “sweep.”

FIG. 2B is a conceptual diagram of a situation where a plurality of still images obtained through the sweep of the image capturing apparatus 1 is appropriately arranged. Of still images obtained through image capturing, frame image data captured from time 0 to time (n−1) in the temporal order of image capturing are shown as frame image data FM#0, FM#1, . . . , FM#(n−1). When a panoramic image is to be generated from n pieces of still images, combining processing is carried out on a series of n pieces of frame image data FM#0 to FM#(n−1) captured successively, as shown in the figure.

As shown in FIG. 2B, since each piece of captured frame image data is typically required to have a portion that overlaps with adjacent frame image data, a time interval at which the image capturing apparatus 1 captures each piece of frame image data and an upper limit value of a speed at which a photographer sweeps may need to be set appropriately.

A group of frame image data arranged as such has a large number of overlapping portions. Therefore, in each piece of the frame image data, a region to use for a final panoramic image may need to be determined. This, in other words, is to determine a seam between images in the panoramic combining processing.

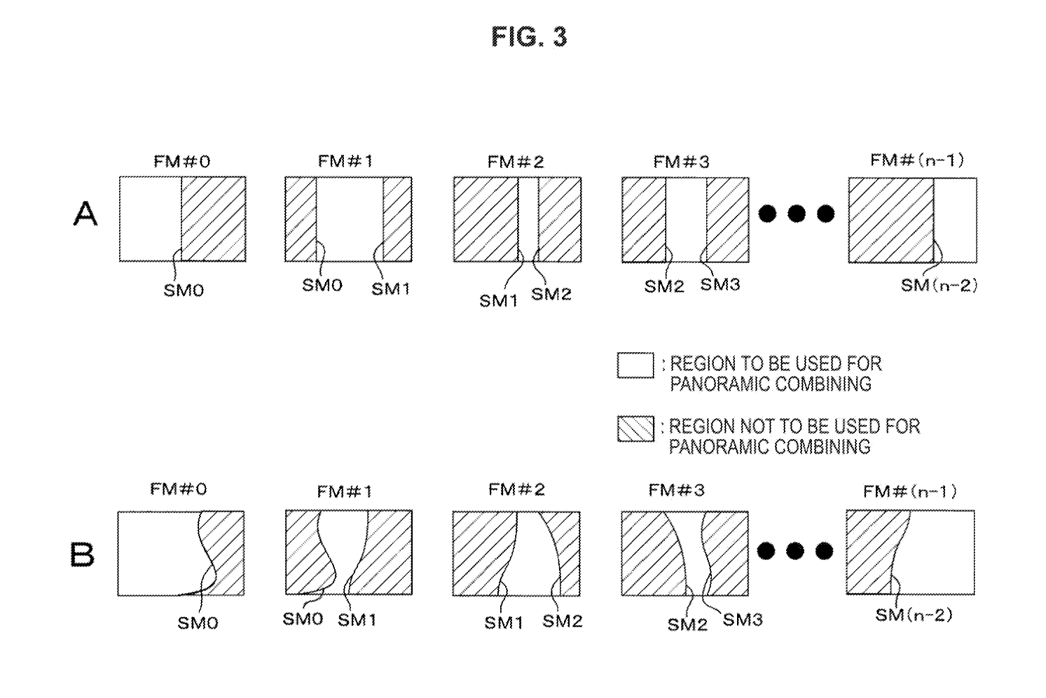

FIG. 3A and FIG. 3B show examples of a seam SM.

A seam can be a straight line that is perpendicular to the sweep direction, as shown in FIG. 3A, or can be non-linear (e.g., curved), as shown in FIG. 3B.

In FIG. 3A and FIG. 3B, a seam SM0 indicates a seam between the frame image data FM#0 and FM#1, a seam SM1 indicates a seam between the frame image data FM#1 and FM#2, . . . , and a seam SM(n−2) indicates a seam between the frame image data FM#(n−2) and FM#(n−1).

These seams SM0 to SM(n−2) serve as the seams between adjacent images when being combined, and thus a shaded portion in each frame image data becomes an image region that is not used in the final panoramic image.

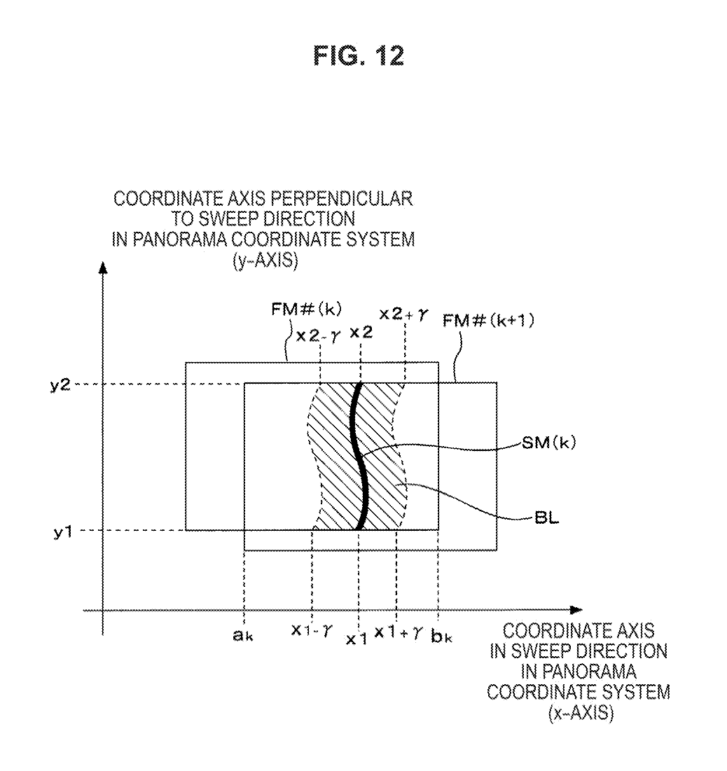

Further, when panoramic combining is carried out, in some cases, blend processing is also carried out on image regions in the vicinity of the seam in order to reduce unnaturalness of the images around the seam. The blend processing will be described later in FIG. 12.

There are cases where a shared portion of each frame image data is joined by carrying out the blend processing over a wide range or where a pixel to contribute to a panoramic image are selected for each pixel from the shared portion. In these cases, although a seam does not exist clearly, a joining portion of such wide range can also be considered as a seam in a broad sense.

Further, as shown in FIG. 2B, as a result of the arranging each frame image data, a slight movement not only in the sweep direction but also in a direction perpendicular to the sweep is typically observed. This is a shift that occurs from a hand jiggle or the like of the photographer at the time of the sweep.

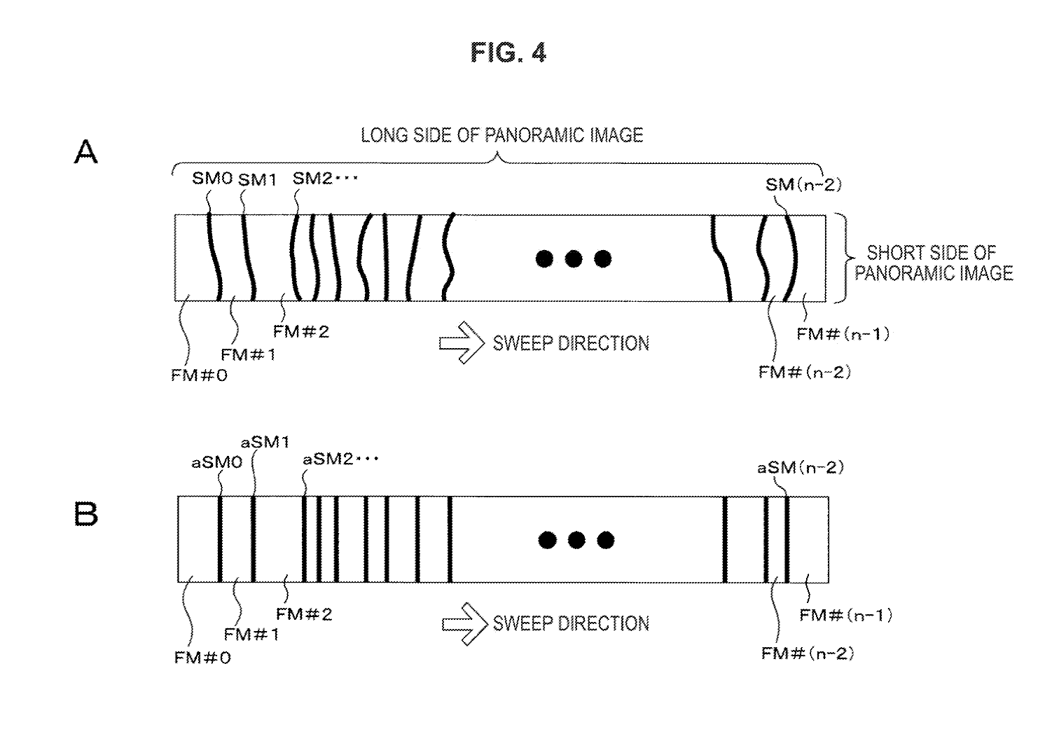

A panoramic image having a wide field angle with the sweep direction being a long side direction, as shown in FIG. 4A, can be obtained by determining a seam of each frame image data, joining by carrying out the blend processing on a boundary region thereof, and finally trimming an unnecessary portion in a direction perpendicular to the sweep taking the hand jiggle amount into consideration.

In FIG. 4A, vertical lines of indeterminate shapes indicate the seams, in which a state where n pieces of frame image data FM#0 to FM#(n−1) are joined at the seams SM0 to SM(n−2), respectively, to generate a panoramic image is schematically shown.

Note that, although the details will be described hereinafter, as processing for determining a seam in the present embodiment, seam references aSM0 to aSM(n−2) to serve as linear reference lines as in FIG. 4B are first determined in a first stage. Then, in a second stage, peripheral regions of the respective seam references aSM0 to aSM(n−2) are searched through to determine the seams SM0 to SM(n−2) of indeterminate shaped lines as shown in FIG. 4A.

### <3. Panoramic Combining Algorithm of Embodiment>

The panoramic combining processing in the image capturing apparatus 1 of the present embodiment will now be described in detail.

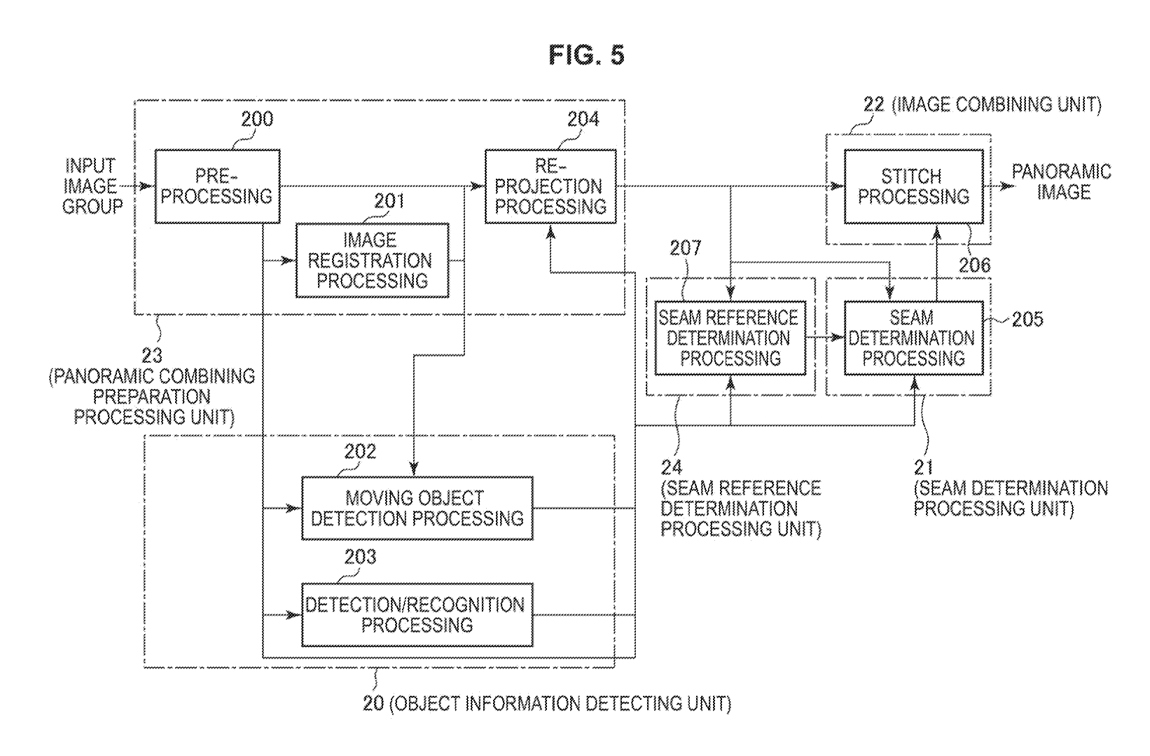

FIG. 5 shows the processing executed in the image processing unit 102 and the control unit 103 for the panoramic combining processing as functional configurations and the processing executed by these functional configurations.

As indicated with dashed-dotted lines, the function configurations include an object information detecting unit 20, a seam determination processing unit 21, an image combining unit 22, a panoramic combining preparation processing unit 23, and a seam reference determination processing unit 24.

The object information detecting unit 20 detects object information for each frame image data in an input process of a series of n pieces of frame image data to be used in panoramic image generation.

In this example, the object information detecting unit 20 carries out moving object detection processing 202 and a detection/recognition processing 203.

The seam reference determination processing unit 24 carries out processing (seam reference determination processing 207) to obtain, using the object information that has been detected by the object information detecting unit 20, a seam reference aSM (aSM0 to aSM(n−2)) that serves as a reference line to determine a seam SM between adjacent frame image data.

The seam determination processing unit 21 carries out processing (seam determination processing 205) to determine, using the object information that has been detected by the object information detecting unit 20, a seam SM between adjacent frame image data in, of an overlapping range between the adjacent frame image data, only within a determining region that is set based on the seam reference aSM between the adjacent frame image data which has been determined by the seam reference determination processing unit 24.

The image combining unit 22 carries out stitch processing 206 to generate panoramic image data using n pieces of frame image data by combining each piece of the frame image data FM#0 to FM#(n−1) in accordance with the seams SM0 to SM(n−2) that have been determined by the seam determination processing unit 21.

The panoramic combining preparation processing unit 23 carries out, for example, pre-processing 200, image registration processing 201, and re-projection processing 204 as preparation processing for carrying out panoramic combining with high precision.

To realize the operation of the present embodiment, it is preferable to include the object information detecting unit 20, the seam reference determination processing unit 24, the seam determination processing unit 21, and the image combining unit 22. However, the processing in the image combining unit 22 or the processing in the object information detecting unit 20 may be carried out by an external device, in which case, the image processing device of the present embodiment includes at least the seam reference determination processing unit 24 and the seam determination processing unit 21.

In other words, in a case where the image processing device is embedded in the image capturing apparatus 1 or where the image processing device is realized in an information processing device such as a computing device to be described later or realized as a single device, that image processing device includes the seam determination processing unit 21 and the seam reference determination processing unit 24. In some cases, the image processing device further includes one or both of the image combining unit 22 and the object information detecting unit 20.

Each processing will be described.

An input image group that is to subjected to the pre-processing 200 includes the frame image data FM#0, FM#1, FM#2, . . . that are sequentially obtained while a photographer carries out panoramic image capturing with the image capturing apparatus 1.

First, the panoramic combining preparation processing unit 23 carries out the pre-processing 200 for the panoramic combining processing on an image (each frame image data) captured through the panoramic image capturing operation of the photographer. Image to be inputted here is assumed to have undergone image processing that is similar to that at normal image capturing.

An inputted image has been affected by aberration in accordance with the properties of the lens unit 100. In particular, a distortion aberration of the lens adversely affects the image registration processing 201 and degrades the precision of the arrangement. Further, the distortion aberration also causes an artifact around the seam in the combined panoramic image. Therefore, the distortion aberration is corrected in the pre-processing 200. Correcting the distortion aberration can lead to the improvement in the precision in the moving object detection processing 202 and the detection/recognition processing 203.

Subsequently, the panoramic combining preparation processing unit 23 carries out the image registration processing 201 on the frame image data that have been subjected to the pre-processing 200.

In panoramic combining, a plurality of frame image data is subjected to coordinate transformation onto a single coordinate system, and this single coordinate system will be referred to as a panorama coordinate system.

The image registration processing 201 is processing where two pieces of successive frame image data are inputted and arrangement on the panorama coordinate system is carried out. Information obtained through the image registration processing 201 on the two pieces of frame image data is merely a relative relationship between the two image coordinates. However, by selecting one of a plurality of image coordinate systems (for example, a coordinate system of first frame image data) and fixing onto the panorama coordinate system, the coordinate systems of all frame image data can be converted onto the panorama coordinate system.

Specific processing to be carried out in the image registration processing 201 is broadly divided into the following two:

1. To detect a local movement in an image; and

2. To obtain a global movement in an entire image from the information on the local movement obtained above.

In the aforementioned processing of 1, typically,
block matching
characteristic point extraction and characteristic point matching such as Harris, Hessian, SIFT, SURF, FAST
   or the like are used to obtain a local vector of a characteristic point in the image.

In the aforementioned processing of 2, with the local vector group obtained through the aforementioned processing of 1 as an input, a robust estimation method such as
least squares method
M-Estimator
least median of squares method (LMedS)
RANSAC (RANdom SAmple Consensus)
   is used to obtain an optimal affine transformation matrix or projection transformation matrix (Homography) that describes the relationship between the two coordinate systems. In the present specification, such information is referred to as image registration information.

The panoramic combining preparation processing unit 23 carries out the re-projection processing 204.

In the re-projection processing 204, the entire frame image data are subjected to projection processing onto a single plane or a single curved surface such as a cylindrical surface or a spherical surface based on the image registration information obtained through the image registration processing 201. At the same time, moving object information and detection/recognition information are also subjected to the projection process onto the same plane or curved surface.

The re-projection processing 204 of the frame image data may be carried out as pre-stage processing of the stitch processing 206 or as a part of the stitch processing 206 with optimization of pixel processing taken into consideration. Alternatively, it may be carried out simply before the image registration processing 201, for example, as a part of the pre-processing 200. More simply, the processing itself may not be carried out and may be treated as an approximation of cylindrical projection processing.

The object information detecting unit 20 carries out the moving object detection processing 202 and the detection/recognition processing 203 on each of the frame image data that have been subjected to the pre-processing 200.

In the panoramic combining processing, due to its nature in that a plurality of frame image data is combined, if a moving object is present in a scene to be captured, a part of the moving object is split or blurred, which causes a failure of the image and a deterioration in the image quality. Thus, it is preferable to determine, after having detected the moving object, a seam in the panorama so as to avoid the moving object.

The moving object detection processing 202 is processing where two or more pieces of successive frame image data are inputted and a moving object is detected. In an example of specific processing, when a difference value in the pixel between two pieces of frame image data that have actually been arranged in accordance with the image registration information obtained through the image registration processing 201 is equal to or greater than a threshold value, that pixel is determined to be a moving object.

Alternatively, determination may be made using characteristic point information that has been determined to be an outlier at the robust estimation in the image registration processing 201.

In the detection/recognition processing 203, positional information of the face or the body of a human, an animal, and the like in the captured frame image data is detected. Humans and animals are likely to be the moving object. Even if they are not moving, when a seam in the panorama is determined over the object, that often causes a visually uncomfortable feeling compared to other objects, and thus it is preferable to determine a seam so as to avoid these objects. That is, information obtained through the detection/recognition processing 203 is used to compensate for the information from the moving object detection processing 202.

The seam reference determination processing 207 and the seam determination processing 205 is processing to determine an appropriate seam SM with less failure as a panoramic image with the image data from the re-projection processing 204, the image registration information from the image registration processing 201, the moving object information from the moving object detection processing 202, and the detection/recognition information from the detection/recognition processing 203 as an input.

At that time, in the seam reference determination processing 207, an optimal seam reference aSM is determined as a linear reference line that is perpendicular to the sweep direction.

Further, in the seam determination processing 205, an optimal seam SM of an indeterminate shaped line is determined by searching within a determining region that is a peripheral region of the seam reference aSM determined in the seam reference determination processing 207.

In this way, two-stage processing is carried out in which an optimal reference line is first determined to serve as the seam reference aSM and the optimal seam SM of an indeterminate shaped line is then determined within the determining region that is based on the reference line.

Here, the seam reference aSM can be said as a seam that is simply obtained. In that sense, it is possible to say that the two-stage processing is that a linear seam is first simply determined and thereafter a seam is set with high precision with a peripheral region of that linear seam serving as a determining region. That is, an optimized final seam (a seam of an indeterminate shaped line) is determined in accordance with image content regardless of being linear or nonlinear.

Specific processing of the seam reference determination processing 207 by the seam reference determination processing unit 24 will be described.

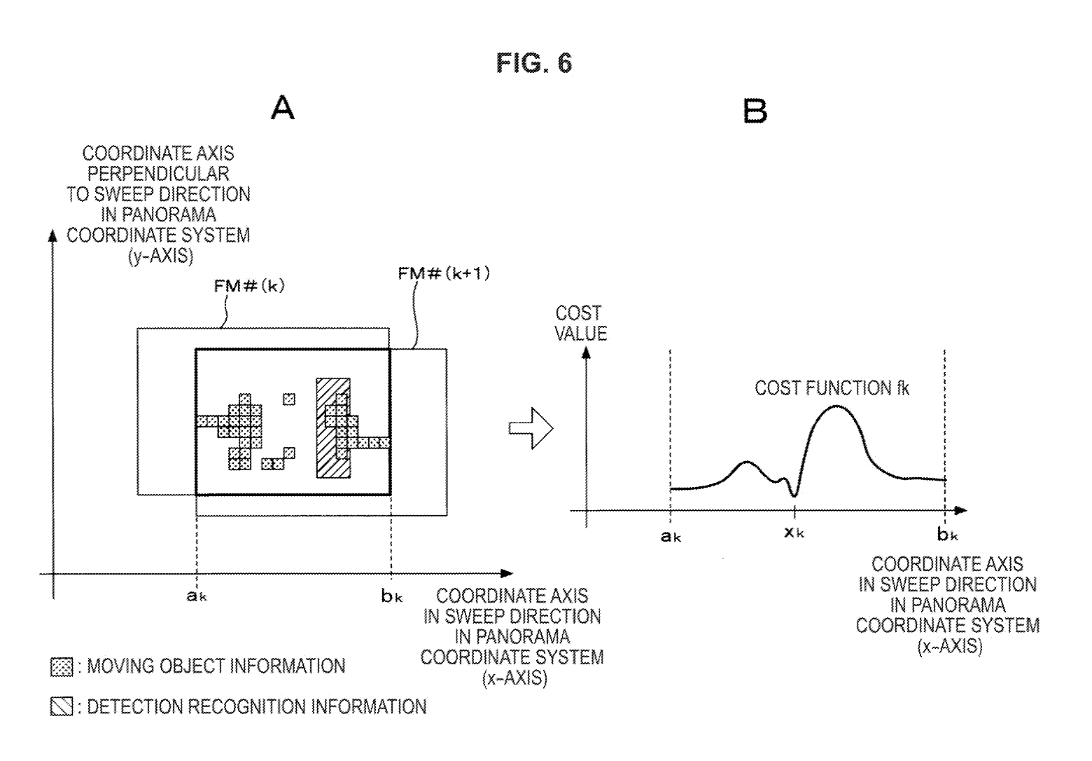

First, the definition of a cost function in an overlapping region will be described with reference to FIG. 6.

In the panorama coordinate system, a coordinate axis in the sweep direction is an x axis, and an axis perpendicular to the x axis is a y axis. It is assumed that frame image data FM#(k) captured at time k in a region where aₖ≦c≦bₖ and frame image data FM#(k+1) captured at time k+1 overlap with each other, as shown in FIG. 6A.

A cost function fₖ(x) is defined as that the moving object information from the moving object detection processing 202 and the detection/recognition information from the detection/recognition processing 203 in an overlapping region (aₖ to bₖ) are appropriately weighted and all pieces of the information are integrated after having been projected in the x axis direction.

That is,

$${f}_{k} ( x ) = {\sum }_{i}^{ } {\sum }_{y}^{ } {mo}_{i} ( x , y ) \cdot {wmo}_{i} ( x , y ) + {\sum }_{i}^{ } {\sum }_{y}^{ } {det}_{j} ( x , y ) \cdot w {det}_{i} ( x , y ) \qquad [ equation 1 ]$$

In the above, defined as
moᵢ=0, 1: moving object detection information (0≦i≦Nₘₒ−1)
wmoᵢ: weighting function for moving object detection information (0≦i≦Nₘₒ−1)
detⱼ=0, 1: detection/recognition information (0≦j≦N_{det}−1)
wdetⱼ: weighting function for detection/recognition information (0≦j≦N_{det}−1)

This means that the higher the cost function value, the more the moving object(s) and the object(s) such as a human body exist(s) on that line. As described above, the final seam SM (and the seam reference aSM) is to be determined so as to avoid these objects in order to minimize a failure in the panoramic image. Therefore, an x coordinate value where the cost function value is low may be selected for the position of the seam reference.

The moving object detection processing 202 and the detection/recognition processing 203 are carried out typically per block having a few to a few tens of pixels on one side, and thus the cost function fₖ(x) is a discrete function in which x is defined by an integer value.

When, for example, the weighting function wmoᵢ for the moving object detection information is the magnitude of a movement amount in the moving object, a region where the object with a larger movement amount is less likely to serve as the seam SM (and the seam reference aSM).

FIG. 6A illustrates an applicable pixel block of the moving object information and the detection/recognition information in the overlapping region (aₖ to bₖ) of the frame image data FM#(k) and the FM#(k+1). In this case, a cost value obtained through the cost function fₖ(x) of the above (equation 1) in a range of aₖ≦x≦bₖ on the x axis, for example, is as shown in FIG. 6B.

An x coordinate value (xₖ) with the lowest cost value serves as a position that is appropriate as the seam SM (and the seam reference aSM) between the two pieces of frame image data FM#(k) and FM#(k+1).

In the seam reference determination processing 207, an x coordinate value that is appropriate as the seam reference aSM is calculated using the cost function as in the above.

It is to be recognized that the description given thus far here is merely for a case that is viewed in the cost function between the two pieces of frame image data. As described in FIG. 4, a panoramic image is generated by joining n pieces of frame image data FM#0 to FM#(n−1) at the seams SM0 to SM(n−2). In this case, the combination of the seams SM0 to SM(n−2) may need to be optimized. For example, the combination is optimized so that such a case that the seam SM2 appears to the left of the seam SM1 in FIG. 4A does not occur.

In the case of the present embodiment, the seam determination processing 205 by the seam determination processing unit 21 determines the seam SM within the determining region that is based on the seam reference aSM as described above. That is, each of the seams SM0 to SM(n−2) is determined within the determining region that is based on each of the seam references aSM0 to aSM(n−2).

Accordingly, in order to optimize the combination of the final seams SM0 to SM(n−2) to be obtained in the seam determination processing 205, the combination of the seam references aSM0 to aSM(n−2) to be obtained between the respective frame image data may be optimized.

Thus, in the seam reference determination processing 207 by the seam reference determination processing unit 24, it is not that a seam reference is determined simply between two pieces of frame image data. This will be described later in detail.

It is considered that the weighting function wdetⱼ for the detection/recognition information is changed in accordance with the type of a detector such as for face detection or human body detection, or is made to be reliability (score value) at the time of detection or changed in accordance with a detected coordinate so that the cost function value is adjusted.

Further, in a case where the detection accuracy and the reliability of the moving object detection processing 202 and the detection/recognition processing 203 differ, the weighting function of higher detection accuracy and higher reliability can be set relatively higher compared to the weighting function of that with lower detection accuracy and lower reliability to reflect the detection accuracy and the reliability on the cost function.

In this way, in the seam reference determination processing unit 24, the cost function fₖ(x) may serve as a function that reflects the reliability of the object information.

Further, the seam reference determination processing unit 24 may make the cost function as a cost function f′ₖ(x) that reflects a spatial condition of an image.

That is, although the cost function fₖ(x) is defined only from the moving object information and the detection/recognition information in the above (equation 1), the new cost function f′ₖ(x) is defined by g(x,fₖ(x)) with respect to the cost function fₖ(x).

f′ₖ(x)=g(x,fₖ(x)) [equation 2]

Using the new cost function f′ₖ(x) makes it possible to adjust a spatial cost value that may not be represented solely with the moving object information and the detection/recognition information.

In general, image quality at a peripheral part of an image tends to be inferior to image quality at the center part thereof due to the influence of aberration of a lens. Thus, the peripheral part of the image is desirably not used for a panoramic image as much as possible. To this end, a seam may be determined around the center in an overlapping region.

Therefore, the cost function f′ₖ(x) may, for example, be defined using g(x,fₖ(x)) as shown below.

$${f}_{k}^{′} ( x ) = g ( x , {f}_{k} ( x ) ) = {t}_{0} \cdot \vert x - \frac{{b}_{k} - {a}_{k}}{2} \vert \cdot {f}_{k} ( x ) + {t}_{1} \qquad [ equation 3 ]$$

In the above, t₀ and t₁ are positive constant values.

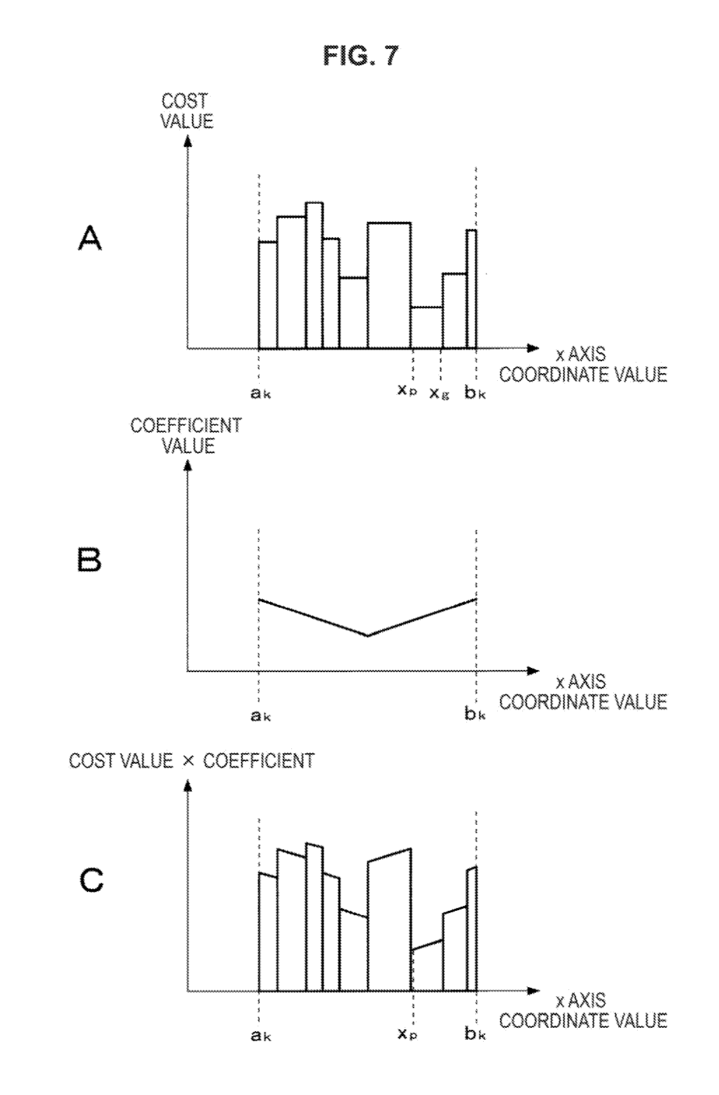

The cost function f′ₖ(x) that reflects the spatial condition will be schematically described in FIG. 7.

FIG. 7A shows cost values obtained through the cost function fₖ(x) of the above (equation 1) in the overlapping region (aₖ to bₖ). Although the cost values are shown in a curved line in FIG. 6B, actually they turn out to be in a bar graph form as shown in FIG. 7A since the cost function fₖ(x) is a discrete function in which x is defined with an integer value.

In this case, since the cost value is the minimum in a range from xp to xq of the x coordinate value in the figure, any x coordinate value within the range of the coordinate values xp to xq may serve as the seam reference. However, as stated above, the seam reference aSM (and eventually the final seam SM) is desirably located around the center in the overlapping region as much as possible.

The term t₀·|x−(bₖ−aₖ)/2| of the above (equation 3) means to provide a coefficient as in FIG. 7B. That is, it is such a coefficient that the closer to the center of the image, the lower the cost becomes. Here, t₁ of (equation 3) is an offset value for preventing a difference in the cost values from being eliminated depending on the coefficient in a case where the cost value through the cost function fₖ(x) is 0 (a portion where a moving object does not exist or the like).

The cost value obtained through the cost function f′ₖ(x) of the above (equation 3) in the overlapping region (aₖ to bₖ) turns out to be as shown in FIG. 7C as coefficient values as in FIG. 7B are reflected in the end. Then, the coordinate value xp is selected as the seam reference aSM. That is, the function is such that the final seam SM is determined around the center in the overlapping region as much as possible.

For example, appropriately designing the cost function as in the above makes it possible to select an optimal seam reference aSM where various conditions are taken into consideration.

Thus far, description has been made that a position where the cost function value becomes the minimum may be obtained to determine the optimal seam reference aSM in the overlapping region of two pieces of frame image data.

Subsequently, a method for obtaining an optimal combination of the seam references aSM0 to aSM(n−2) when combining n (n>2) pieces of frame image data will be described.

When the n pieces of frame image data FM#0 to FM#(n−1) are considered, the number of overlapping regions is n−1, and the number of cost functions to be defined is also n−1.

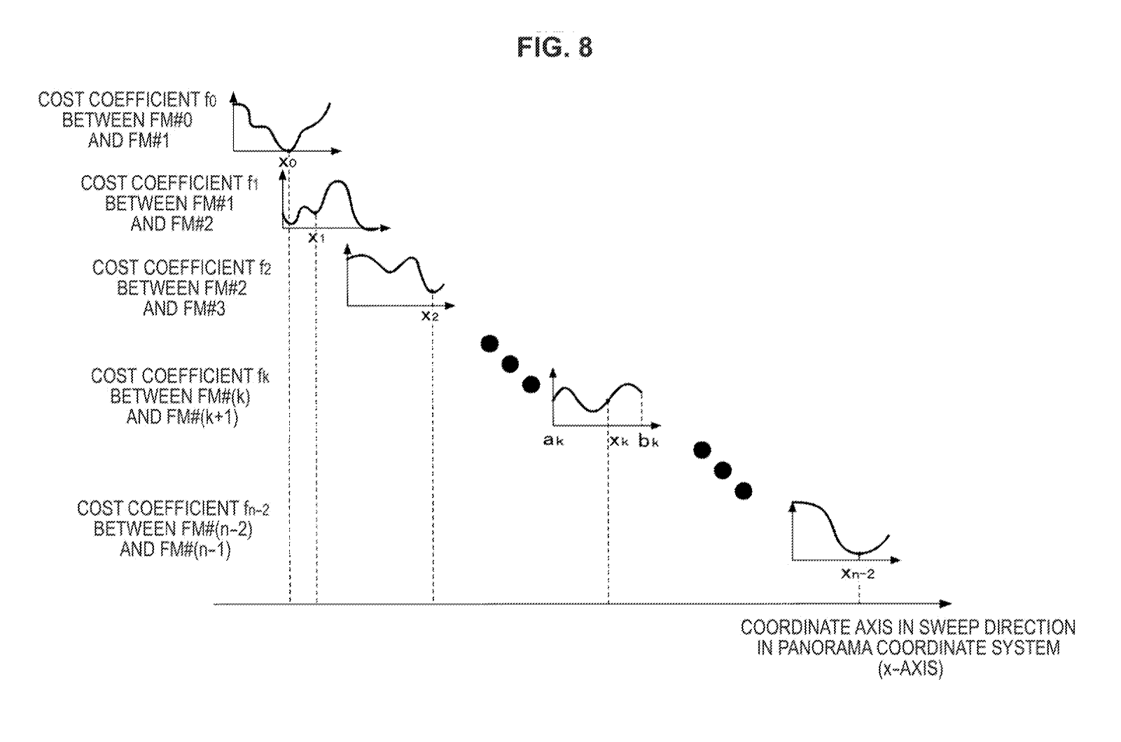

FIG. 8 shows a relationship of the cost functions for the case where the n pieces of frame image data are considered. That is, FIG. 8 shows a cost function f₀ between the frame image data FM#0 and FM#1, a cost function f₁ between the frame image data FM#1 and FM#2, . . . , and a cost function fₙ₋₂ between the frame image data FM#(n−2) and FM#(n−1).

In order to panoramically combine the n pieces of frame image data and select optimal seams as a whole, x₀, x₁, . . . , and xₙ₋₂ that minimize

$$F ( {x}_{0} , {x}_{1} , … , {x}_{n - 2} ) = {\sum }_{k = 0}^{n - 2} {f}_{k} ( {x}_{k} ) \qquad [ equation 4 ]$$

may be obtained.

Here, xₖ is an integer value that satisfies the following.
xₖ₋₁+α≦xₖ≦xₖ₊₁−α (constraint for seam)
aₖ≦xₖ≦bₖ (domain of cost function)

Here, α is a constant value that defines a minimum interval of adjacent seam references aSM (or seams SM).

A problem for minimizing the above (equation 4) is typically called a combination optimization problem, and the following solving methods are known.
Solving Method to Obtain Exact Solution
branch and bound method
memorization
dynamic programming
graph cut
Solving Method to Obtain Approximate Solution
local search method (hill climbing method)
simulated annealing
taboo search
genetic algorithm

The minimization problem of the (equation 4) can be solved through any one of the aforementioned methods.

Through the above-described processing, the optimal seam references aSM0 to aSM(n−2) as linear lines that are perpendicular to the sweep direction can be determined.

Here, a case where, with respect to all n pieces of frame image data FM#0 to FM#(n−1) to be panoramically combined, n−2 seam references aSM0 to aSM(n−2) between adjacent frame image data are obtained, respectively, has been discussed. This method will be used in a panoramic combining processing example I to be described later as a specific processing example.

However, in panoramic combining processing examples II and III, seam references aSM0 to aSM(m−1) are obtained through optimal position determination processing that uses the object information detected by the object information detecting unit 20, for each group of (m+1) pieces of frame image data (here, m<n) in a input process of a series of n pieces of frame image data to be used for panoramic image generation. Then, processing to determine m or less seam references is sequentially carried out in an input process of a series of frame image data.

In this way, when processing to obtain m seam references is sequentially carried out on m+1 pieces of frame image data (here, m<n), m seam references (for example, x₀, x₁, . . . , and xₘ) that minimize the above (equation 4) may be obtained.

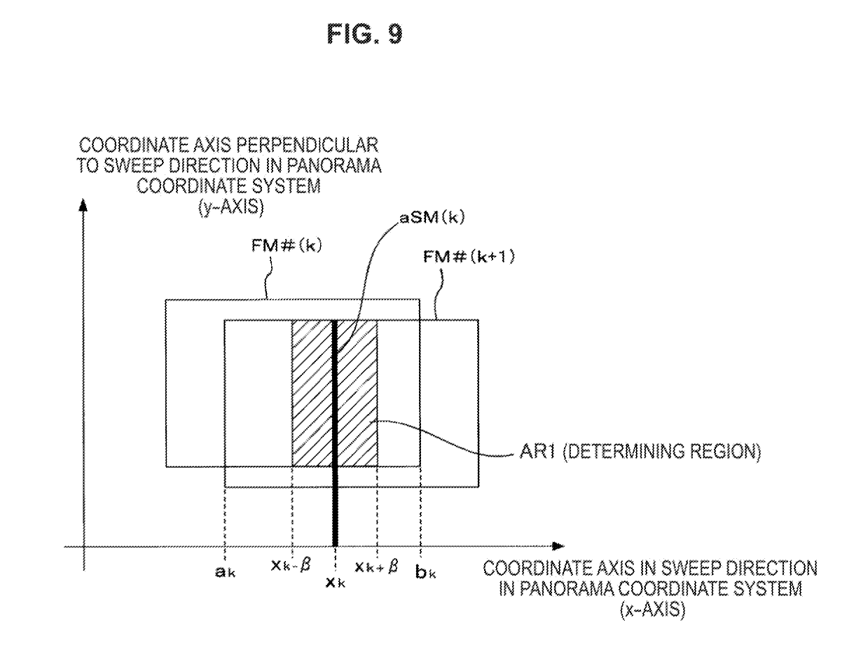

An example of the seam reference aSM determined by the seam reference determination processing unit 24 as described above and an example of a determining region AR1 that is based on the seam reference aSM are shown in FIG. 9.

FIG. 9 illustrates a seam reference aSM(k) in an overlapping region (aₖ to bₖ) of frame image data FM#(k) and FM#(k+1). In this case, the assumption is that the cost function fₖ(x) has been set, and an x-coordinate value (xₖ) has finally been determined as the seam reference aSM(k) between the two pieces of frame image data FM#(k) and FM#(k+1) through combination optimization of the above (equation 4).

The seam reference aSM(k) is a straight line that is perpendicular to the sweep direction (x-axis direction) as shown in the figure.

Then, for example, a range that is within a predetermined distance β from the line serving as the seam reference aSM(k) in the sweep direction and the direction opposite thereto, that is, a shaded region that ranges from (xₖ−β) to (xₖ+β) in the x-coordinate value is defined as the determining region AR1.

In the seam determination processing 205 by the seam determination processing unit 21, a two-dimensional cost search is carried out only with respect to this determining region AR1 to determine the final seam SM.

Specific processing in the seam determination processing 205 will now be described.

It is considered that an indeterminate shaped seam that does not split a moving object and is less likely to fail as a panoramic image is present in the vicinity of neighborhood region of a linear seam (that is, a straight line serving as a seam reference aSM). Thus, in the seam determination processing 205, a search is conducted partially only within the determining region AR1 around the seam reference aSM, and an optimal indeterminate shaped seam SM is determined.

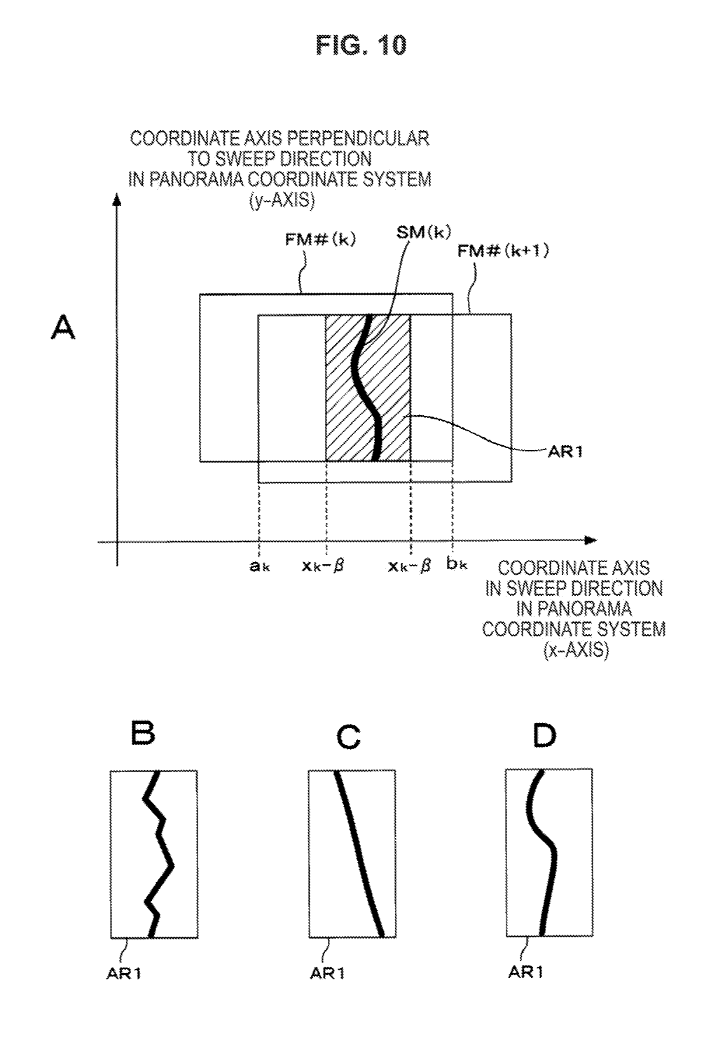

An example of the indeterminate shaped seam SM is shown in FIG. 10A. The seam SM is to be determined within the determining region AR1.

The indeterminate shaped seam SM obtained as such is an approximate solution of sufficient precision with respect to an indeterminate shaped seam in a case where optimization is carried out with respect to the entire overlapping region (aₖ to bₖ) between the frames.

That is, without searching through the entire overlapping region (aₖ to bₖ), narrowing down a search to within the determining region AR1 that ranges from (xₖ−β) to (xₖ+β) makes it possible to, while greatly reducing a processing load, determine a seam with precision that stands comparison with that in a case where the entire overlapping region (aₖ to bₖ) is searched through.

Here, the determined seam SM is still obtained through a two-dimensional cost search within the determining region AR1, and thus the shape of a line to be determined as the final seam SM is indeterminate. For example, it may be a serpentine curve as in FIG. 10A or may be a polygonal line as shown in FIG. 10B. Further, it may be a straight line as in FIG. 10C or may be a line where a curved portion and a linear portion are connected as in FIG. 10D.

A method for obtaining an optimal indeterminate shaped seam SM within the determining region AR1 will now be described.

A cost function gₖ(x,y) is defined as that the moving object information from the moving object detection processing 202 and the detection/recognition information from the detection/recognition processing 203 in (xₖ−β) to (xₖ+β) as the determining region AR1 are appropriately weighted, respectively.

Unlike the cost function in the case of the above-described seam reference determination processing 207, one-dimensional projection is not carries out, and thus it is a function of two variables.

### That is,

$${g}_{k} ( x , y ) = {\sum }_{i}^{ } {mo}_{i} ( x , y ) \cdot {wmo}_{i} ( x , y ) + {\sum }_{j}^{ } {det}_{j} ( x , y ) \cdot w {det}_{j} ( x , y ) \qquad [ equation 5 ]$$

In the above, defined as
moᵢ=0, 1: moving object detection information (0≦i≦Nₘₒ−1)
wmoᵢ: weighting function for moving object detection information (0≦j≦N_{det}−1)
detᵢ=0, 1: detection/recognition information (0≦j≦N_{det}−1)
wdetⱼ: weighting function for detection/recognition information (0≦j≦N_{det}−1)

Further, as another cost function, an absolute value of a difference in luminance of pixels in the determining region AR1 may be selected. That is,

gₖ(x,y)=|Iₖ(x,y)−Iₖ₊₁(x,y)| [equation 6]

Here, Iₖ(x,y) is a luminance value of pixels in the frame FM#(k) in the panorama coordinates (x,y).

With respect to these cost functions, as a method for obtaining an indeterminate shaped path that minimizes the cost,
dynamic programming
a graph cut
   are known in general, and it is possible to obtain an exact solution through a pseudo-polynomial time.

Through the above-described processing, a seam SM that is extremely close to the optimum can be determined in an overlapping region between two frames.

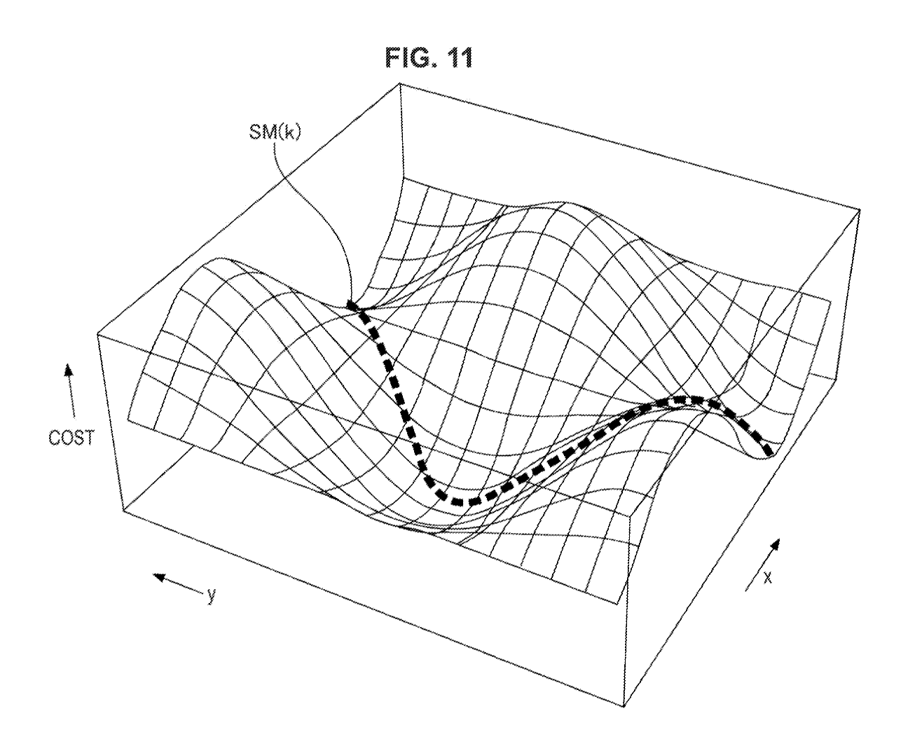

FIG. 11 shows an image of processing to obtain the seam SM through a cost search by a function with two variables. FIG. 11 is a schematic diagram where the vertical axis indicates the cost value of each pixel in the x-coordinate range and the y-coordinate range to serve as the determining region AR1.

The indeterminate shaped path that minimizes the cost is a path that follows a trough portion in the drawing shown in FIG. 11. That is, that path is the seam SM(k) shown in the thick broken line.

In general, with a method where an indeterminate shaped seam is searched for with respect to the entire overlapping region of two frames, a wide range of two-dimensional cost function may need to be held, and thus an amount of used memory increases. Further, since a search range is broad, the calculation cost also increases.

In addition, in a case where a plurality of overlapping regions themselves overlap with one another, obtained indeterminate shaped seams may intersect with one another, in which case, exception handling may need to be carried out or complicated constraints may need to be applied.

On the contrary, with the method of the present embodiment, since a two-dimensional search is conducted only within the determining region AR1 in the vicinity of the seam reference aSM obtained as a straight line seam, an amount of memory for holding the cost function as well as the calculation cost are small. Further, if a relationship between a restriction α when obtaining the seam reference aSM and a restriction β when obtaining the final seam SM is set as in α≧β, there is no such risk that a plurality of indeterminate shaped seams SM intersect with one another, and thus processing is simplified.

As a result, a processing speed is increased.

In the image combining unit 22 in FIG. 5, the stitch processing 206 is carried out.

In the stitch processing 206, a panoramic image is finally generated using the information on all of the seams SM0 to SM(n−2) determined in the seam determination processing 205 and the frame image data FM#0 to FM#(n−1).

In this case, although adjacent frame image data may simply be connected at a seam, it is preferable to carry out blend processing for improved image quality.

An example of the blend processing will be described in FIG. 12. FIG. 12 schematically illustrates the frame image data FM#(k) and FM#(k+1) to be combined. The determined seam SM(k) is shown with a thick line.

Here, a range of the overlapping region of the frame image data FM#(k) and FM#(k+1) along the y-axis is from y1 to y2.

Further, the x-coordinate value of the seam SM where the y-coordinate=y1 is x1, and the x-coordinate value of the seam SM where the y-coordinate value=y2 is x2.

The image combining unit 22 carries out the blend processing on a blend region BL shown as a shaded portion, which is within a predetermined distance y from a line serving as the seam SM in the sweep direction and the opposite direction thereof, to combine the two pieces of frame image data, and thus unnaturalness at the seam is reduced.

As for the y-coordinate value=y1, a range from x1−γ to x1+γ falls within the blend region BL. As for the y-coordinate value=y2, a range from x2−γ to x2+γ falls within the blend region BL.

With respect to a region other than the above (a non-shaded portion of the overlapping region), a pixel value is simply copied or only re-sampling onto the panorama coordinate system is carried out, and all the images are combined.

The blend processing is carried out through the following calculation.

$${PI}_{k} ( x , y ) = \frac{γ + {x}_{k} - x}{2 γ} \cdot {I}_{k} ( x , y ) + \frac{γ - {x}_{k} + x}{2 γ} \cdot {I}_{k + 1} ( x , y ) \qquad [ equation 7 ]$$

PIₖ(x, y): pixel value of panoramic image in panorama coordinate (x, y)

Iₖ(x, y): pixel value of frame image data FM#(k) in panorama coordinate (x, y)

That is, the calculation of the above (equation 5) may be carried out with respect to each y-coordinate in y1 to y2 within the shaded blend region BL to carry out the blend processing.

Through the above-described stitch processing 206 by the image combining unit 22, a panoramic combined image can be obtained from the n pieces of frame image data.

### <4. Setting Example of Determining Region>

Various examples of setting the determining region AR1 will now be described.

As described in FIG. 9, it is considered to set the determining region AR1 to a region that ranges within a distance β from the seam reference aSM in ±directions along the x-axis.

Various specific setting examples of this distance β can be assumed. For example, the value of β may be a fixed value or may be set variably.

If the distance β is set to a fixed pixel number PX, the determining region AR1 is uniquely determined as a range of ±PX from the x-coordinate value x of the seam reference aSM once the seam reference aSM is determined. That is, it is a range from (xₖ−PX) to (xₖ+PK).

In this case, however, the x-coordinate range (xₖ−PX) to (xₖ+PX) of the determining region AR1 may become equal to or greater than the overlapping region (aₖ to bₖ) of the frames. If that is the case, the determining region AR1 is the entire overlapping region (aₖ to bₖ) of the frames, but in such a case, the determining region AR1 is a small region to begin with, and thus processing for the two-dimensional cost search in the seam determination processing 205 is not high.

The distance β may, for example, be set as a value of a predetermined percentage of the overlapping region (aₖ to bₖ). For example, when a value at 10% of the distance of the overlapping region (aₖ to bₖ) is set as β, the determining region AR1 is a region of 20% of the overlapping region (aₖ to bₖ) with the seam reference aSM serving as the center line.

Further, the configuration may be such that a user can arbitrarily set or select a value for the case where the distance β is a fixed pixel number or a value for the case where the distance β is set to a value of a predetermined percentage of the overlapping region (aₖ to bₖ). As the determining region AR1 is set smaller, a calculation load in the seam determination processing 205 becomes lighter and the processing speed increases. However, the precision of the seam SM increases as the determining region AR1 is wider. Accordingly, it is advantageous to allow a user to be able to set arbitrarily depending on whether the processing speed is prioritized or whether the seam quality is prioritized.

Further, the value of the distance β can be varied in accordance with the reliability of the determined seam reference aSM.

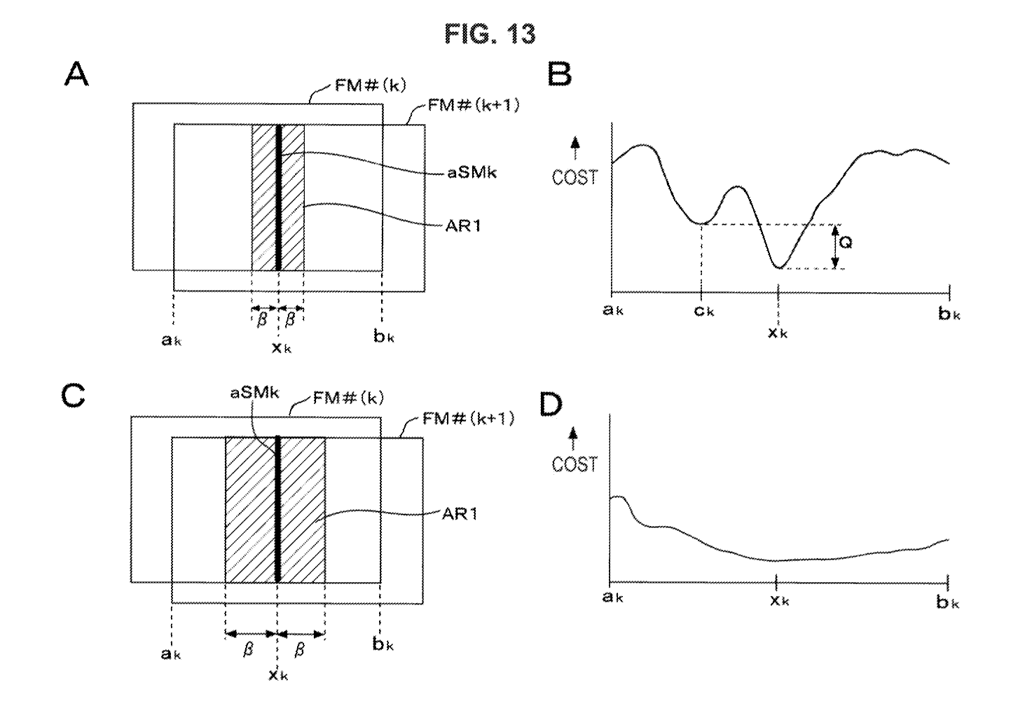

FIG. 13A shows a state where the β value is decreased to make the determining region AR1 smaller, and FIG. 13C shows a state where the β value is increased to make the determining region AR1 broader. In this way, varying the value of the distance β allows the determining region AR1 to be optimized.

For example, suppose the cost values in the overlapping region (aₖ to bₖ) are as shown in FIG. 13B. In this case, a difference Q between an x-coordinate value (xₖ) that is the smallest value where the cost is the lowest and an x-coordinate value (cₖ) that is the second smallest value is relatively large. In the case of such a cost distribution, a possibility of the x-coordinate value (xₖ) and therearound being the most appropriate as a seam is high, and it can be said that setting the x-coordinate value (xₖ) to serve as the seam reference aSM yields high reliability. Then, even when the β value is decreased to make the determining region AR1 smaller as in FIG. 13A, a possibility that the highly precise seam SM can be determined is high. In that case, there is an advantage in that the calculation load in the seam determination processing 205 can be reduced.

On the other hand, suppose the cost values in the overlapping region (aₖ to bₖ) are smoothly distributed as shown in FIG. 13D. If this is the case, the x-coordinate value (xₖ) that is the smallest value where the cost is the lowest is not a characteristic coordinate value as compared to the other x-coordinate values, and the reliability that the x-coordinate value (xₖ) and therearound is the most appropriate as a seam is low. In such a case, in order to secure the precision of the seam SM, it is considered to increase the β value to make the determining region AR1 broader as in FIG. 13C, even if the calculation load increases.

Further, although the determining region AR1 has been set to ±β with the seam reference aSM being the center line, the determining region AR1 may be a region that is horizontally asymmetric from the seam reference aSM.

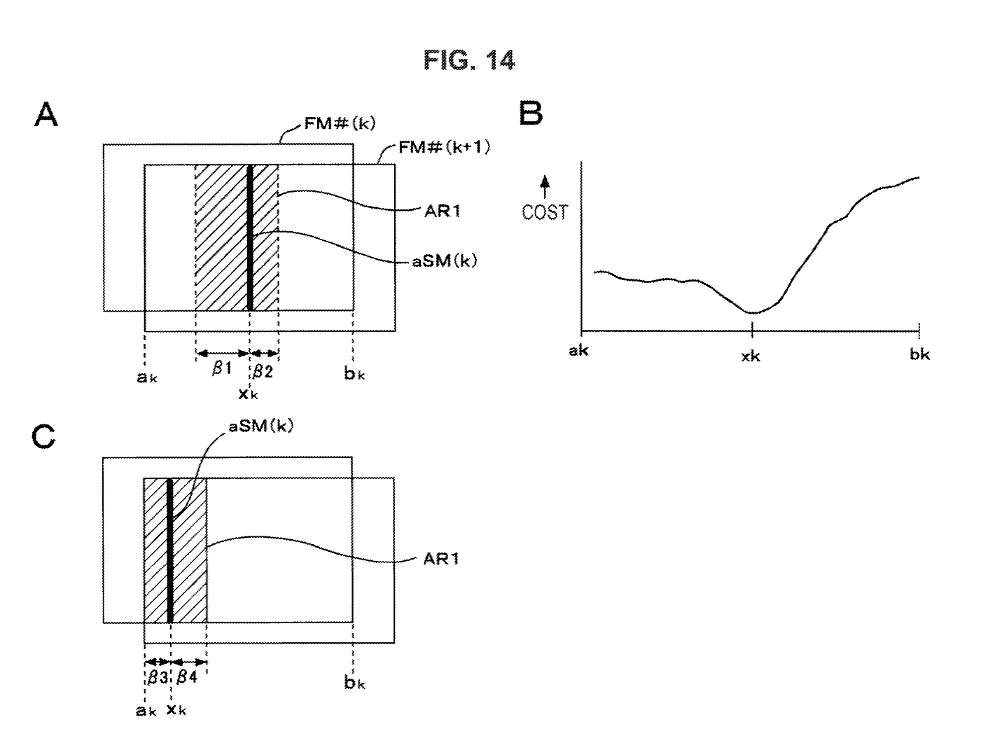

FIG. 14A shows an example where a range in −β1 and +β2 from the seam reference aSM at the x-coordinate value (xₖ) is set as the determining region AR1.

The determining region AR1 is simply a region for searching for a highly precise seam SM, and a range to serve as the determining region AR1 does not need to have the seam reference aSM as its center. For example, suppose the cost values in the overlapping region (aₖ to bₖ) are distributed as in FIG. 14B, where the costs tend to be lower toward the aₖ side of the x-coordinate value (xₖ). In this case, a value as in β1>β2 is set, and the determining region AR1 is broadened toward the aₖ side as in FIG. 14A. Then, carrying out a search for the seam SM allows the precision of the seam SM to further increase.

Further, FIG. 14C shows a case where the seam reference aSM is determined to a position close to an edge at the aₖ side in the overlapping region (aₖ to bₖ).

In such a case, the left edge of the determining region AR1 is naturally restricted to the x-coordinate value=aₖ. Thus, it is considered that, as in β3<β4, the determining region AR1 is secured broader toward the bₖ side so that the range for searching for the seam SM does not become excessively small.

Thus far, the setting examples of the determining region AR1 have been illustrated, but aside from the above, setting examples of the determining region AR1 can be considered.

### <5. Use of Low Resolution Image/High Resolution Image>

Here, an example will be described where object information obtained from images of distinct resolutions is used in the seam reference determination processing 207 and the seam determination processing 205.

For example, in the seam reference determination processing 207, the seam reference aSM is determined using object information obtained from a low resolution image.

Meanwhile, in the seam determination processing 205, the seam SM is determined using object information obtained from a high resolution image.

Through this, an amount of used memory and a calculation cost can be reduced without degrading the performance.

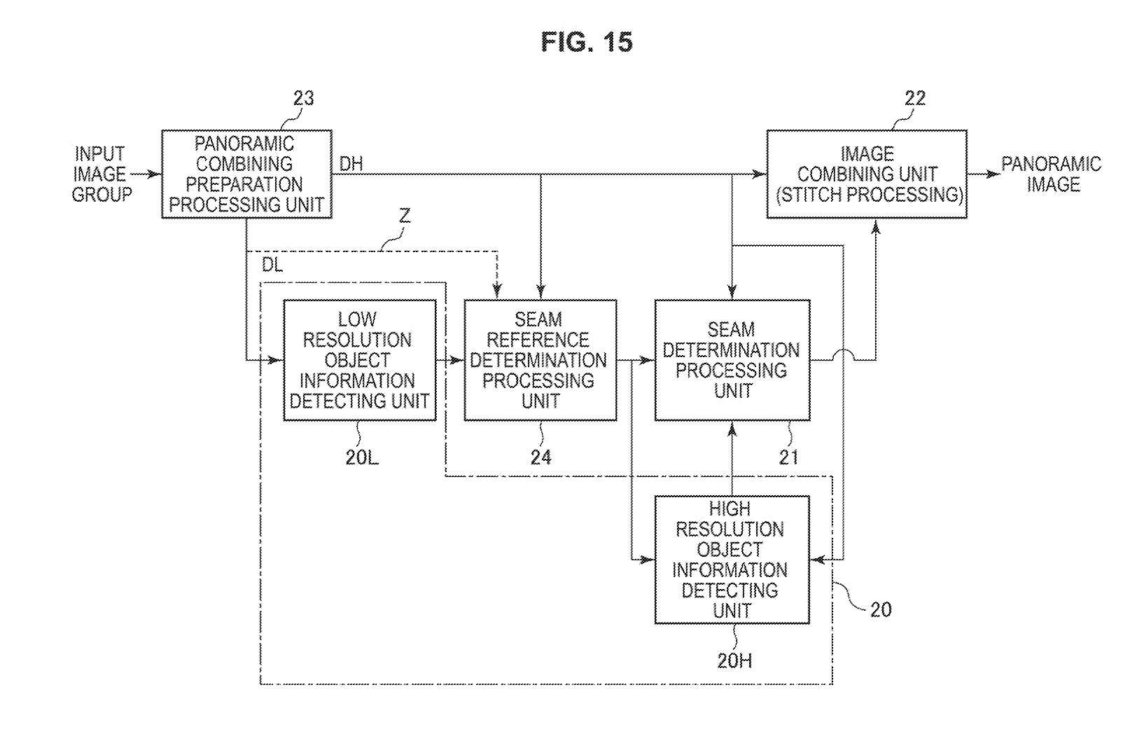

In this case, it is considered that the image processing device takes on a configuration shown in FIG. 15, in place of the configuration in FIG. 5.

The configuration in FIG. 15 includes, similarly to FIG. 5, the panoramic combining preparation processing unit 23, the object information detecting unit 20, the seam reference determination processing unit 24, the seam determination processing unit 21, and the image combining unit 22. In this configuration, the object information detecting unit 20 includes a low resolution object information detecting unit 20L that detects object information in low resolution image data and a high resolution object information detecting unit 20H that detects object information in high resolution image data.

Each of the low resolution object information detecting unit 20L and the high resolution object information detecting unit 20H carries out the moving object detection processing 202 and the detection/recognition processing 203 described in FIG. 5.

Low resolution frame image data DL are supplied to the low resolution object information detecting unit 20L from the panoramic combining preparation processing unit 23.

Meanwhile, the panoramic combining preparation processing unit 23 supplies high resolution frame image data DH to the seam reference determination processing unit 24, the seam determination processing unit 21, the image combining unit 22, and the high resolution object information detecting unit 20H.

With respect to the low resolution frame image data DL, the low resolution object information detecting unit 20L carries out the moving object detection processing 202 and the detection/recognition processing 203 to supply object information to the seam reference determination processing unit 24.

With respect to the frame image data DH, the seam reference determination processing unit 24 determines the seam reference aSM using object information obtained by the low resolution object information detecting unit 20L. Then, information on the seam reference aSM (or information on the determining region AR1) is handed to the seam determination processing unit 21 and the high resolution object information detecting unit 20H.

The high resolution object information detecting unit 20H carries out, on the high resolution frame image data DH, object information detection, that is, the moving object detection processing 202 and the detection/recognition processing 203 only within the range of the determining region AR1. Then, the object information is outputted to the seam determination processing unit 21.

The seam determination processing unit 21 carries out two-dimensional cost function processing using the object information from the high resolution object information detecting unit 20H within the range of the determining region AR1 that is based on the seam reference aSM determined by the seam reference determination processing unit 24, to thereby determine the seam SM.

The stitch processing of the image combining unit 22 is the same as that in FIG. 5.

By carrying out such processing, for example, while effectively using the low resolution object information detecting unit 20L, an amount of used memory and the calculation cost for determining the seam SM can be reduced without losing the determination precision of the seam SM. As for determining the seam reference aSM, even if it is rough, the precision can be retained as a seam search is carried out with the object information from the high resolution image in the second-stage seam determination processing unit 21.

Note that other examples where object information is detected using low resolution frame image data can also be considered.

For example, in the configuration in FIG. 5, the panoramic combining preparation processing unit 23 may provide the lower resolution frame image data only to the object information detecting unit 20. That is, the moving object detection processing 202 and the detection/recognition processing 203 in the object information detecting unit 20 are to be carried out with the low resolution frame image data.

Using the objected information obtained as a result, the seam reference determination processing 207 by the seam reference determination processing unit 24 and the seam determination processing 205 by the seam determination processing unit 21 are carried out.

By doing so, an amount of used memory and the calculation cost can be further reduced.

Subsequently, an example will be described where images of distinct resolutions are used in the seam reference determination processing 207 and the seam determination processing 205. That is, images of distinct resolutions are used not only in the object information detection but also in the determination processing itself of the seam reference aSM and the seam SM.

The seam reference determination processing unit 24 determines the seam reference aSM using image data of a first resolution (low resolution frame image data DL). Meanwhile, the seam determination processing unit 21 determines the seam SM using the frame the image data DH that are higher in resolution than the image data of the first resolution.

For example, as shown with a broken line Z in FIG. 15, the low resolution frame image data DL are supplied to the seam reference determination processing unit 24.

With respect to the frame image data DL, the seam reference determination processing unit 24 determines the seam reference aSM using the object information obtained by the low resolution object information detecting unit 20L. Then, information on the seam reference aSM (or information on the determining region AR1) is handed to the seam determination processing unit 21 and the high resolution object information detecting unit 20H.

The processing in the high resolution object information detecting unit 20H, the seam determination processing unit 21, and the image combining unit 22 is the same as the above.

That is, in this example, the low resolution frame image data DL are used not only to detect the object information but also for the seam reference determination processing.

Through such processing as well, while effectively using the low resolution object information detecting unit 20L, an amount of used memory and the calculation cost for determining the seam SM can be reduced without losing the determination precision of the seam SM. As for determining the seam reference aSM, even if it is carried out roughly using the low resolution frame image data DL, the precision can be retained as a seam search is carried out using the object information from the high resolution image in the second-stage seam determination processing unit 21 and using the high resolution frame image data DH.

Other examples where images of distinct resolutions are used for determination processing itself of the seam reference aSM and the seam SM can also be considered.

For example, in the configuration in FIG. 5, the low resolution frame image data DL are supplied to the seam determination processing unit 21, and the seam reference aSM is determined using this. Meanwhile, the high resolution frame image data DH are supplied to the seam determination processing unit 21, and the seam SM may be determined using this.

To summarize the above, the following examples can be assumed as examples of using the lower resolution frame image data.
The low resolution frame image data are used to detect object information to be used to determine the seam reference aSM.
The low resolution frame image data are used to detect object information to be used both to determine the seam reference aSM and to determine the seam SM.
The seam reference aSM is determined using the low resolution frame image data.

Through the above, an amount of used memory and the calculation cost for determining the seam SM can be reduced without degrading the determination precision of the seam SM.

### <6. Panoramic Combining Processing Example I>

A panoramic combining processing example of the present embodiment carried out with the functional configurations shown in FIG. 5 or FIG. 15 will be described below.

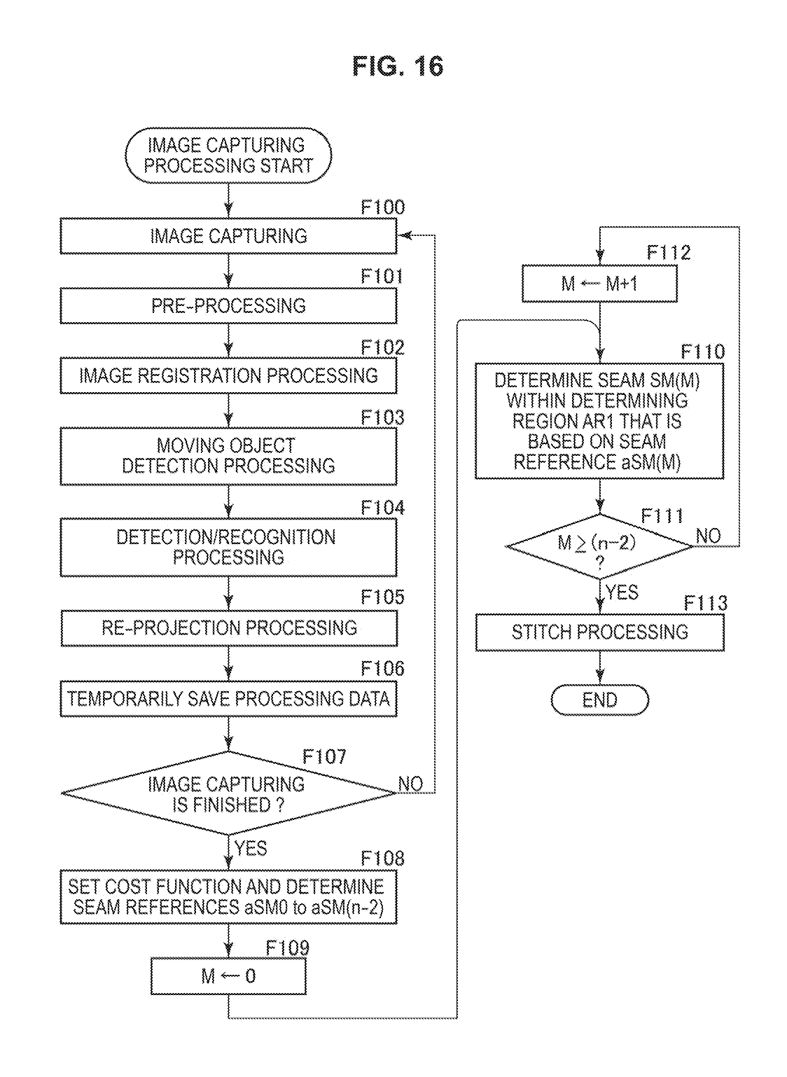

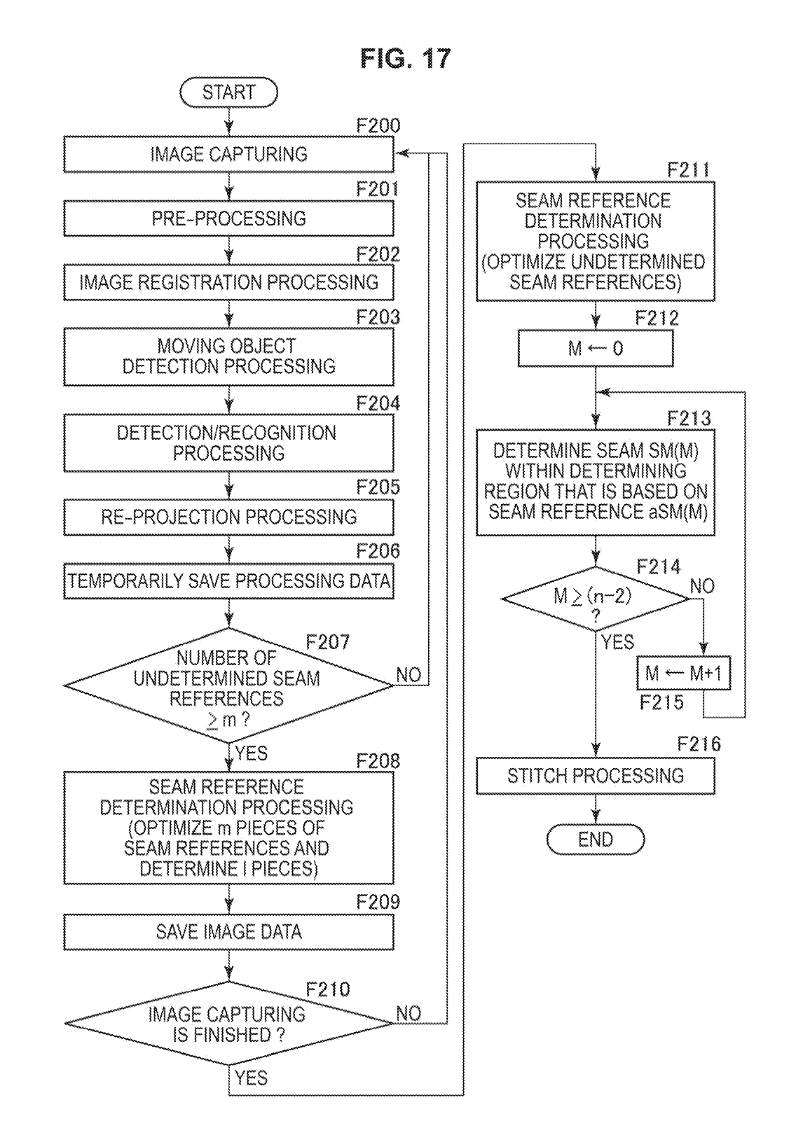

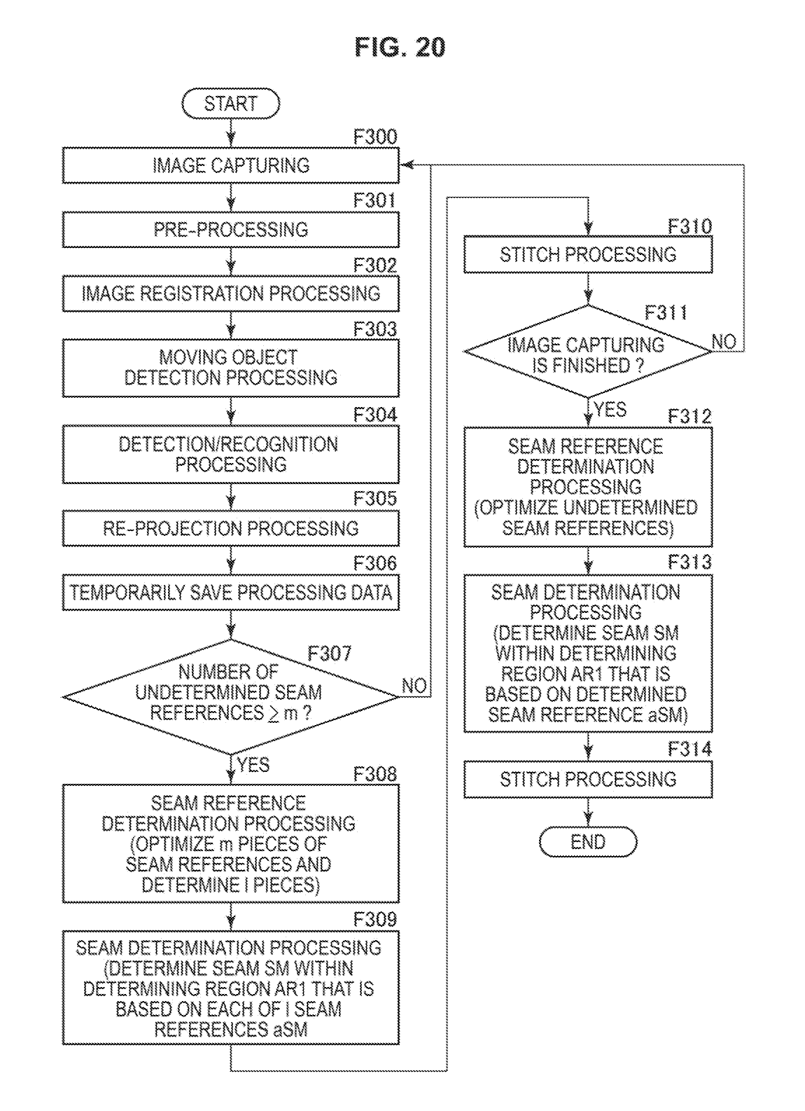

First, a panoramic combining processing example I will be described with reference to FIG. 16. FIG. 16 (and FIG. 17 and FIG. 20 to be described later) is a flowchart in which several control elements are added to the processing elements to be carried out mainly in each function configuration shown in FIG. 5. In the processing of FIG. 16, the corresponding processing of FIG. 5 is merely additionally described in the following description for the processing of the same name as the processing elements of FIG. 5 and duplicate and detailed description thereof is omitted.

Image capturing of step F100 refers to processing where one still image is captured in a panoramic image capturing mode and that is taken into as a single piece of frame image data within the image capturing apparatus 1. That is, through the control by the control unit 103, an image capturing signal obtained in the image capturing device 101 is subjected to an image capturing signal processing by the image processing unit 102 to turn into a single piece of frame image data.

The frame image data may be provided for the panoramic combining processing (processing after step F101 by each unit in FIG. 5) in the image processing unit 102 as is, or may once be taken into the memory unit 105 and then provided for the panoramic combining processing in the image processing unit 102 as one piece of frame image data.

In each unit in FIG. 5 (the panoramic combining preparation processing unit 23, the object information detecting unit 20, the seam reference determination processing unit 24, the seam determination processing unit 21, the image combining unit 22) realized by the image processing unit 102 and the control unit 103, the processing after step F101 is carried out in accordance with an input of the frame image data based on step F100.

In step F101, the panoramic combining preparation processing unit 23 carries out pre-processing (the pre-processing 200 in FIG. 5).

In step F102, the panoramic combining preparation processing unit 23 carries out image registration processing (the image registration processing 201 in FIG. 5).

In step F103, the object information detecting unit 20 carries out moving object detection processing (the moving object detection processing 202 in FIG. 5).

In step F 104, the object information detecting unit 20 carries out detection/recognition processing (the detection/recognition processing 203 in FIG. 5).

In step F105, the panoramic combining preparation processing unit 23 carries out re-projection processing (the re-projection processing 204 in FIG. 5).

In step F106, processing data up to step F105 are temporarily saved in the memory unit 105. That is, processing data to be used in panoramic combining such as the pixel information of the image, the image registration information, the moving object detection information, the detection/recognition information and so on are temporarily saved. Further, the frame image data itself is also temporarily saved in the memory unit 105 if not yet saved at this point.

This is processing in which the panoramic combining preparation processing unit 23 and the object information detecting unit 20 temporarily store various data and the image to hand to the seam determination processing unit 21.

The above-described processing is repeated until a determination that image capturing is finished is made in step F 107.

When the image capturing is finished and n pieces of frame image data FM#0 to FM#(n−1) for panoramic image generation and the object information and the like thereof are secured, the processing proceeds to step F108.

In step F108, the seam reference determination processing unit 24 carries out processing to determine the seam references aSM0 to aSM(n−2) (the seam reference determination processing 207 in FIG. 5).

That is, the cost function f₀ between the frame image data FM#0 and FM#1, the cost function f₁ between the frame image data FM#1 and FM#2, . . . , and the cost function fₙ₋₂ between the frame image data FM#(n−2) and FM#(n−1) are set.

Then, x₀, x₁, . . . , and xₙ₋₂ that minimize the above (equation 4) are obtained.

The obtained x₀, x₁, . . . , and xₙ₋₂ are determined as the x-coordinate values of the seam references aSM0 to aSM(n−2).

Subsequently, in steps F109 to F111, the seam determination processing unit 21 carries out processing to determine the seams SM0 to SM(n−2) (the seam determination processing 205 in FIG. 5).

First, in step F109, the seam determination processing unit 21 sets a variable M=0. Then, in step F110, the seam determination processing unit 21 carries out processing to determine the seam SM(M) within the determining region AR1 that is based on the seam reference aSM(M).

First of all, since the variable M=0, a calculation is carried out to obtain a path that minimizes the cost in the two-dimensional cost function of the (equation 5) or the (equation 6) within the determining region AR1 that is set based on the x-coordinate value x₀ serving as the seam reference aSM0 in the overlapping region of the frame image data FM#0 and FM#1, and the seam SM0 is determined.

Then, the seam determination processing unit 21 carries out the processing in step F 110 while incrementing the variable M in step F 112 until the variable M becomes M≧(n−2) in step F111, that is, until calculations of all the seams SM0 to SM(n−2) finish. That is, the seams SM are sequentially determined as in the seam SM1, SM2, SM3, . . . .

Once up until the seam SM(n−2) is determined, the processing proceeds from step F111 to F113.

In step F113, the image combining unit 22 carries out the stitch processing 206. That is, frame image data are joined at the respective seams SM0 to SM(n−2). The blend processing is also carried out when joining them.

In this way, a single piece of panoramic image data as shown in FIG. 4A is generated.

As described above, according to the panoramic combining processing example I in FIG. 16, the linear seam references aSM0 to aSM(n−2) that are perpendicular to the sweep direction are first obtained, and the seams SM0 to SM(n−2) of indeterminate shaped lines are then determined within the determining region AR1 that is based on the respective seam references aSM0 to aSM(n−2).

Through this two-stage processing, it becomes possible to set a seam with high precision and with a high degree of flexibility without increasing a processing load by reducing a memory capacity and reducing a calculation cost. As a result, a high-quality panoramic image can be realized with high-speed processing.

### <7. Panoramic Combining Processing Example II>

A panoramic combining processing example II of the embodiment will be described with reference to FIG. 17.

In the panoramic combining processing example II, the object information detecting unit 20 detects object information of frame image data in an input process of a series of n pieces of frame image data to be used in panoramic image generation. Then, the seam reference determination processing unit 24 sequentially carries out, in an input process of the frame image data, processing to determine l, which is m or less, pieces of seam references aSM (m≧l: l is at least 1 or more) for each group of (m+1) (here, m<n) pieces of frame image data.

That is, before the input of all of n pieces of frame image data is completed, the seam reference determination processing 207 is sequentially carried out.

In this case, by obtaining each seam in the group of (m+1) pieces of frame image data, seam references that take the plurality of frame image data overall into consideration are to be determined.

Further, with respect to the frame image data for which the seam reference aSM has been determined, an image portion that is apparently not used in panoramic combining thereafter is determined.

For example, in a relationship between the two pieces of frame image data FM#(k) and FM#(k+1) shown in FIG. 9, as the seam reference aSM(k) is determined and as the determining region AR1 is determined, an image in a range from the x-coordinate value (xₖ+β) to the x-coordinate value (bₖ) of the frame image data FM#(k) becomes unnecessary. Meanwhile, as for the frame image data FM#(k+1), an image in a range from the x-coordinate value (xₖ−β) to the x-coordinate value (aₖ) becomes unnecessary. In this way, as the determining region AR1 is determined in association with the determination of the seam reference aSM, in the respective frame image data, a region that becomes unnecessary thereafter is determined. Accordingly, only necessary image portions are stored as image data to be used in the subsequent panoramic combining, and unnecessary sections are not stored. Through this, an amount of images to be stored in the processing process can be reduced.

In FIG. 17, since steps F200 to F206 are the same as steps F100 to F106 in FIG. 16, the description thereof will be omitted.

Then, in the processing in FIG. 17, steps F201 to F206 are repeated for each input of frame image data obtained in step F200 until the number of undetermined seam references aSM reaches or exceeds m in step F207.

The seam reference determination processing unit 24 carries out the processing in accordance with the determination in the step F207.

That is, in step F207, when the undetermined seam references aSM is determined to have reached or exceeded m, that is, when the number of frame image data that have been temporarily stored and in which the seam reference aSM has not been determined becomes m+1, the seam reference determination processing unit 24 carries out optimization of the (equation 4) through the above-described method with respect to the m pieces of seams in step F208. Of the m solutions resulting from the optimization, l (l≦m) seam references aSM in the order from the start of image capturing are determined.

Further, in step F209, the seam reference determination processing unit 24 stores, in the memory unit 105, frame image date in which the seam reference aSM has been determined.

In this case, since the seam reference aSM has been determined and the determining region AR1 has been determined, a pixel data portion that does not contribute to the panoramic image in the end does not need to be saved, and only the necessary portions may be stored. Accordingly, an unnecessary portion of image data in the frame image data is deleted.

The above-described processing in steps F200 to F209 is repeated until the determination that the image capturing is finished is made in step F210. That the image capturing is finished in step F210 is processing where the control unit 103 carries out a determination as to whether the image capturing in the panoramic image capturing mode is finished. Conditions for the image capturing to be finished include:
the photographer released a shutter button;
image capturing at a specified field angle is finished;
the number of captured images has exceeded a specified number;
an amount of hand jiggle in a direction perpendicular to the sweep direction has exceeded a specified amount; and
other errors.

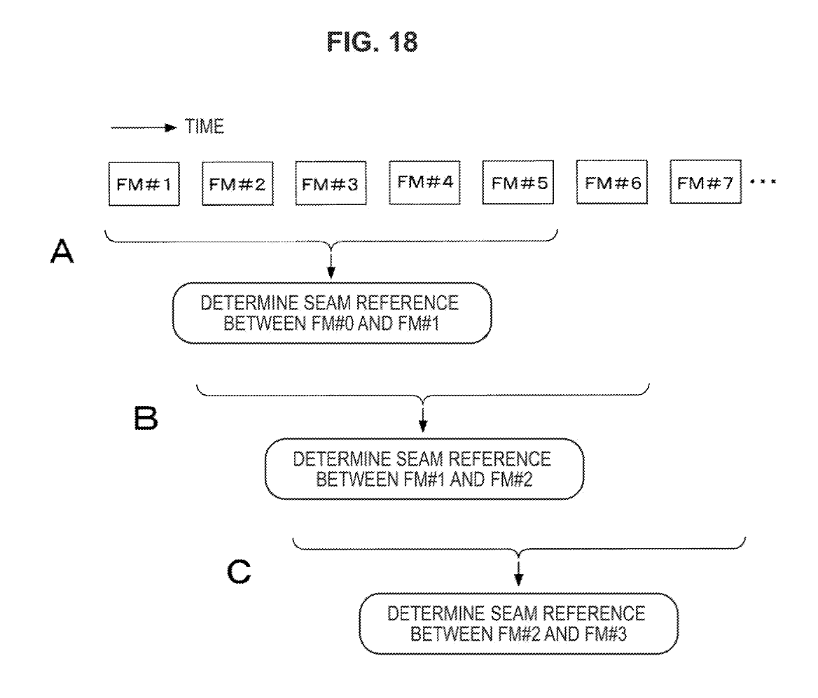

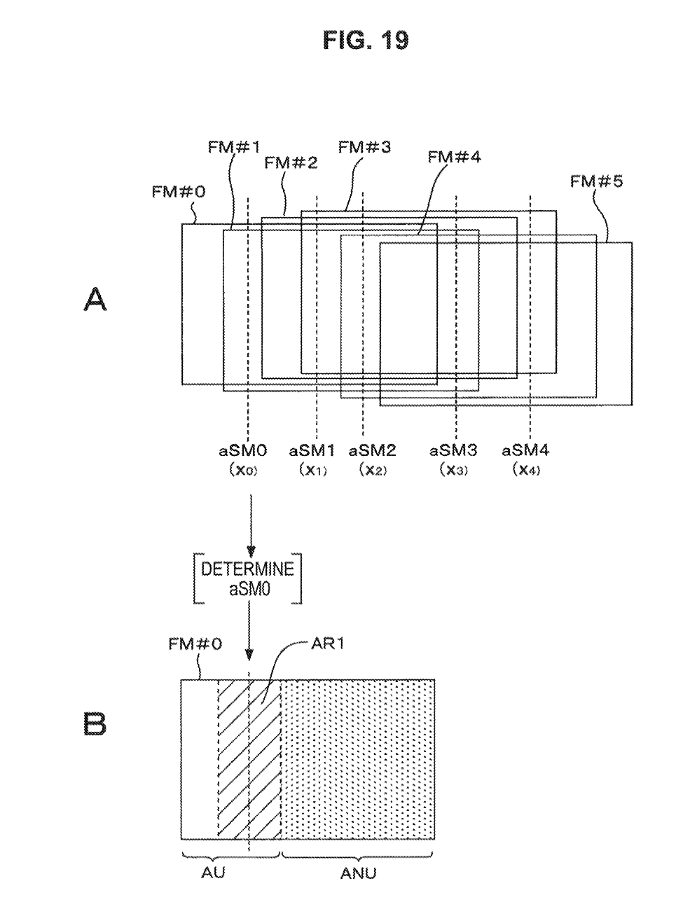

The processing in the above-described steps F207, F208, and F209 will be described with reference to FIG. 18 and FIG. 19.

Here, as one example, a determination standard of the number of undetermined seam references aSM in step F207 is set as m=5. Further, the number of seams to be determined in step F208 is set as l=1.

FIG. 18 shows frame image data FM#0, FM#1, . . . to be sequentially inputted.

Since the number of the undetermined seam references aSM is 4 or less in within a period after first frame image data FM#0 are inputted in step F200 until fifth frame image data FM#4 are inputted, steps F201 to F206 are repeated for each input of the respective frame image data (FM#0 to FM#4).

At a point in time when sixth (that is, m+1th) frame image data FM#5 are inputted and processing up to step F206 is carried out, in step F207, the number of undetermined seam references aSM is 5. Therefore, the number of undetermined seam references becomes ≧m, and the processing proceeds to step F208.

In this case, in step F208, the seam reference determination processing unit 24 obtains, through optimal position determination processing that uses the object information detected through the moving object detection processing 202 (step F203) and the detection/recognition processing 203 (step F204) of the respective frame image data, m seam references aSM0 to aSM4 between the adjacent frame image data, with respect to the group of (m+1) pieces of frame image data (that is, the frame image data FM#0 to FM#5). Then, l (for example, 1) seam reference aSM is determined.

The optimal position determination processing at this time is processing to optimize five seam references aSM0 to aSM4 between the frame image data FM#0 and FM#1, between the frame image data FM#1 and FM#2, between the frame image data FM#2 and FM#3, between the frame image data FM#3 and FM#4, and between the frame image data FM#4 and FM#5. That is, the five seam references aSM0 to aSM4 obtained through the cost function fₖ of the above (equation 1) (or fₖ of the above (equation 3)) for the respective adjacent frame image data are optimized through the above (equation 4).

Then, of the optimized five seam references aSM0 to aSM4, 1, for example, one seam reference aSM0 in the ascending order is determined.

FIG. 19A is a schematic diagram. Although FIG. 19A shows the frame image data FM#0 to FM#5 being superimposed on the panorama coordinates, the x-coordinate values x₀ to x₄ to serve as the seam references aSM0 to aSM4 between the respective adjacent frame image data are optimized through the above (equation 4).

Then, the leading one seam reference aSM0 is determined as the x-coordinate value x₀.

In step F209, frame image data in which the seam reference has been determined is saved, but in this case, a part of the frame image data FM#0 is saved as shown in FIG. 19B. That is, as the seam reference aSM0 is determined and the determining region AR1 for seam determination that is the next processing is determined, the image region of the frame image data FM#0 is divided into a region Au that has a possibility to be used in a panoramic image and a region ANU that is determined not to be used in the panoramic image. In step F209, only the region AU may be saved.

Then, the entire image data of the frame image data FM#0 that has temporarily been saved in step F206 may be deleted at this point.

As described above, for example, in the first steps F208 and F209, the five seam references aSM0 to aSM4 are optimized with respect to the frame image data FM#0 to FM#5 as shown in FIG. 18A, one seam reference, that is, the seam reference aSM0 between the frame image data FM#0 and FM#1 is determined, and a necessary image region is saved.

Thereafter, the subsequent frame image data FM#6 are inputted, and steps F201 to F206 are carried out.

In the above-described first step F208, merely one seam reference aSM0 has been determined, and thus the number of undetermined seam references in step F207 after the frame image data FM#6 have been inputted is five.

Thus, this time, as shown in FIG. 18B, in step F208, five seam references aSM1 to aSM5 are optimized with respect to the frame image data FM#1 to FM#6, and one seam reference, that is, the seam reference aSM1 between the frame image data FM#1 and FM#2 is determined. Then, in step F209, a necessary image region of the frame image data FM#1 is saved.

Similarly, after frame image data FM#7 is inputted, as shown in FIG. 18C, in step F208, five seam references aSM2 to aSM6 are optimized with respect to the frame image data FM#2 to FM#7, and one seam reference, that is, the seam reference aSM2 between the frame image data FM#2 and FM#3 is determined. Then, in step F209, a necessary image region of the frame image data FM#2 is saved.

In this way, the seam reference determination processing unit 24 obtains each of the m seam references aSM between the adjacent frame image data for each group of (m+1) frame image data through the optimal position determination processing and sequentially carries out processing to determine l, which is m or less, seam references aSM in an input process of the frame image data.

Here, although one seam reference is determined with l=1, when m=5, the number l of the seam references to be determined may be 2 to 5.

The processing in steps F200 to F209 in FIG. 17 is continued until the determination that image capturing is finished is made in step F210.

Once the image capturing is finished, in step F211, the seam reference determination processing unit 24 determines seam references aSM that are undetermined at that point in the similar manner as above. As a result, the entire seam references aSM0 to aSM(n−2) as shown in FIG. 4B are determined with respect to the total of n pieces of frame image data FM#0 to FM#(n−1).

Subsequently, in steps F212 to F215, the seam determination processing unit 21 carries out processing to determine the seams SM0 to SM(n−2) (the seam determination processing 205 in FIG. 5).

First, in step F212, the seam determination processing unit 21 sets a variable M=0. Then, in step F213, the seam determination processing unit 21 carries out processing to determine a seam SM(M) within the determining region AR1 that is based on a seam reference aSM(M).

First of all, since the variable M=0, a calculation is carried out to obtain a path that minimizes the cost in the two-dimensional cost function of the (equation 5) or the (equation 6) within the determining region AR1 that is set based on the x-coordinate value x₀ serving as the seam reference aSM0 within the overlapping region of the frame image data FM#0 and FM#1, and the seam SM0 is determined.

Then, the seam determination processing unit 21 carries out the processing in step F213 while incrementing the variable M in step F215 until the variable M becomes M≧(n−2) in step F214, that is, until calculations of all of the seams SM0 to SM(n−2) are finished. That is, the seams SM are sequentially determined as in the seam SM1, SM2, SM3, . . . .

Once up until the seam SM(n−2) is determined, the processing proceeds from step F214 to F216.

In step F216, the image combining unit 22 carries out the stitch processing 206. That is, the frame image data are joined at the respective seams SM0 to SM(n−2). The blend processing is also carried out when joining them.

In this way, a single piece of panoramic image data as shown in FIG. 4A is generated.

In the case of the panoramic combining processing example II in FIG. 17 as well, the linear seam references aSM0 to SM(n−2) that are perpendicular to the sweep direction are first obtained, and the seams SM0 to SM(n−2) of indeterminate shaped lines are then determined within the determining region AR1 that is based on the respective seam references aSM0 to aSM(n−2). Through this two-stage processing, it becomes possible to set a seam high precision and with a high degree of flexibility without increasing a processing load by reducing the memory capacity and reducing the calculation cost. As a result, a high-quality panoramic image can be realized with high-speed processing.

Further, according to the panoramic combining processing example II in FIG. 17, the seam reference determination processing 207 is sequentially carried out without waiting for the image capturing of all of the frame image data to be finished.

Then, the entire image data are saved at the most only for m+1 piece of the frame image data when temporarily saved in step F206. As for n−m−l pieces of frame image data, only pixel data of a portion that has a possibility to contribute to a panoramic image may be saved, and a required memory amount is greatly reduced.

For example, in the case of typical panoramic combining processing, not only is a seam between two pieces determined through a cost function, in order to optimize each seam taking all of the frame image data into consideration, each seam (the seam referred to here corresponds to the seam reference aSM in the present embodiment) is to be determined after the entire n pieces of frame image data are inputted.

Then, the n pieces of frame image data may need to be saved until image capturing of all the images is finished in the processing process, and thus a memory amount necessary for temporarily saving the dada is increased. In particular, as the resolution becomes higher and a data size of a single piece of frame image data is increased, a memory amount that may be required to store the n pieces of frame image data becomes enormous. This leads to deterioration in usage efficiency of the memory. Further, in an embedded device that has very limited memory, realization may not be possible unless a countermeasure is taken such as reducing the resolution of a capturing image or reducing the number of capturing images.

On the other hand, in the case of the panoramic combining processing example II, as described above, the required memory amount is greatly reduced. Therefore, even with the image capturing apparatus 1 or the like that has very limited memory, generation of a high quality panoramic combined image becomes possible without reducing the resolution or reducing the number of capturing images. That is, if the panoramic combining processing example II is carried out as the present embodiment, a seam reference aSM is determined gradually from a group of small number of images (m+1 pieces: for example a few pieces) where image capturing, registration, and processing such as various detection processing have been finished, and the seam references aSM of the entire panoramic image are progressively determined by repeating the above. Therefore, image data that have already become unnecessary can be deleted, and usage efficiency of the memory can be greatly improved. In particular, in an embedded device in which installed memory is limited, panoramic combining at the high resolution and at wide field angle that may have been hard to be realized in the past becomes possible.

Then, the optimal seam references aSM are obtained for the group of (m+1) pieces of frame image data while taking the plurality of frame image data overall into consideration. The final seams SM0 to SM(n−2) of indeterminate shaped lines are located in the vicinity of the seam references aSM0 to aSM(n−2) that have been determined with the plurality of frame image data overall taken into consideration. As a result, the determined seams SM0 to SM(n−2) are located appropriately.

### <8. Panoramic Combining Processing Example III>

A panoramic combining processing example III of the embodiment will be described with reference to FIG. 20.

In the panoramic combining processing example III, not only the seam reference determination processing but also the seam determination processing and the stitch processing of the images in which the seams SM have been determined are carried out without waiting for capturing of all images to finish.

In the case of the panoramic combining processing example III, the object information detecting unit 20 detects object information of frame image data in an input process of a series of n pieces of frame image data to be used in panoramic image generation.

Further, the seam reference determination processing unit 24 sequentially carries out, in an input process of the frame image data, processing to determine l, which is m or less, seam references aSM (m≧l: l is at least 1 or more) for each group of (m+1) pieces (here, m<n) of frame image data.

The above is the same as in the above-described panoramic combining processing example II.

However, in the panoramic combining processing example III, the seam determination processing unit 21 additionally carries out processing to determine a seam SM within the determining region AR1 that is set based on the determined seam reference aSM each time the processing to determine the m or less seam references aSM is carried out by the seam reference determination processing unit 24.

Further, the image combining unit 22 sequentially carries out the stitch processing of the frame image data in which the seam SM has been determined.

In FIG. 20, since steps F300 to F308 are the same as steps F200 to F208 in FIG. 17, duplicate description thereof will be omitted.

In the case of FIG. 20, each time the seam reference determination processing unit 24 determines l seam references aSM in step F308, the seam determination processing unit 21 carries out processing to determine l seams SM in step F309. That is, a calculation to obtain a path that minimizes the cost with respect to the two-dimensional cost function of the (equation 5) or the (equation 6) within the determining region AR1 that is based on the determined seam reference aSM is carried out, and a seam SM is determined.

Further, in step F310, the image combining unit 22 carries out the stitch processing.

The above processing is repeated until image capturing is finished.

After image capturing is determined to be finished in step F311, the seam reference determination processing unit 24 determines remaining seam references aSM in step F312. Then, based on the determined seam references aSM, the seam determination processing unit 21 carries out processing to determine the seams SM in step F313.

Thereafter, in step F314, the image combining unit 22 carries out the stitch processing based on the remaining determined seams to complete the panoramic image data.

Through the processing in FIG. 20 as well, similar effects as those of the processing in FIG. 17 can be obtained. In the case of the processing in FIG. 20, it becomes unnecessary to save the image data of the pixel portion to be used in the panoramic image of the n−m−l pieces of frame image data, which is a part of the processing in FIG. 17, and the memory amount can be further reduced.

Further, since even the stitch processing is started while capturing images, time it takes for entire panoramic combining processing can be further reduced.

### <9. Application to Program and Computing Device>

Thus far, the embodiment as the image capturing apparatus 10 that includes the image processing device of FIG. 5 or FIG. 15 has been described. However, the above-described panoramic combining processing can also be carried out by hardware or by software.

A program of the embodiment is a program that causes an arithmetic processing device such as a CPU (Central Processing Unit) and a DSP (Digital Signal Processor) to execute the processing described in the above embodiment.

That is, this program causes the arithmetic processing device to carry out the seam reference determination processing in which a seam reference to serve as a reference line for determining a seam between adjacent two pieces of frame image data of a series of n pieces (n is a natural number equal to or greater than 2) of frame image data to be used for panoramic image generation is determined using object information of the adjacent two pieces of frame image data.

Further, the program causes the arithmetic processing device to execute the seam determination processing in which a seam between the adjacent two pieces of frame image data is determined within the determining region that is set based on the seam reference determined in the seam reference determination processing using the object information of the adjacent two pieces of frame image data.

Here, the program may also cause the arithmetic processing device to execute the object information detection to detect the object information of the series of n pieces of frame image data to be used in the panoramic image generation.

Specifically, the program of the embodiment may be a program that causes the arithmetic processing device to execute the panoramic combining processing shown in FIG. 16, FIG. 17, or FIG. 20.

Through such a program, the image processing device that carries out the above-described panoramic combining processing can be realized using the arithmetic processing device.

Such a program can be recorded in advance on an HDD serving as a recording medium embedded in a device such as a computing device or on a ROM or the like within a microcomputer having a CPU.

Alternatively, the program can be temporarily or permanently stored (recorded) on a removable recording medium such as a flexible disk, a CD-ROM (Compact Disc Read Only Memory), an MO (Magnet optical) disk, a DVD (Digital Versatile Disc), a Blu-ray disk, a magnetic disk, a semiconductor memory, and a memory card. Such a removable recording medium can be provided as so-called packaged software.

Further, such a program can be installed onto a personal computer or the like from a removable recording medium and can also be downloaded from a download site through a network such as a LAN (Local Area Network) and the internet.

Further, such a program is suitable for widely distributing the image processing device of the embodiment. For example, by downloading the program onto a personal computer, a portable information processing device, a mobile phone, a game console, a video device, a PDA (Personal Digital Assistant), or the like, such a portable information processing device or the like can serve as the image processing device of the embodiment of the present disclosure.

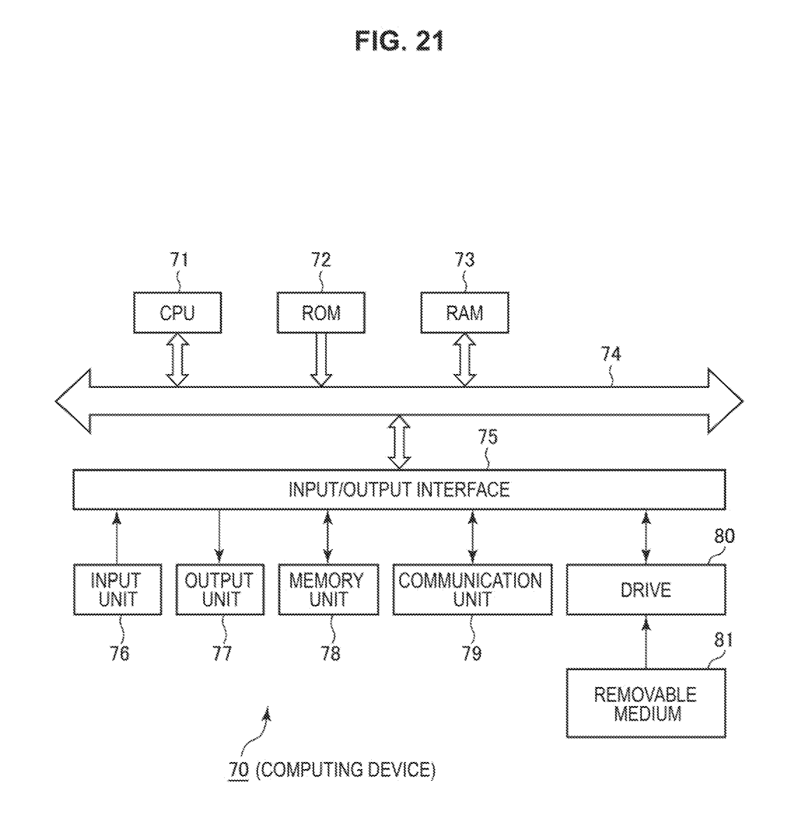

For example, in a computing device shown in FIG. 21, processing similar to the panoramic combining processing in the image capturing apparatus 1 of the embodiment can be carried out.

In FIG. 21, a CPU 71 of a computing device 70 executes various processing in accordance with a program recorded in a ROM 72 or a program loaded onto a RAM 73 from a memory unit 78. Data or the like that may be necessary when the CPU 71 executes various processing are also stored on the RAM 73 as appropriate.

The CPU 71, the ROM 72, and the RAM 73 are connected to one another through a bus 74. The bus 74 is also connected to an input/output interface 75.

An input unit 76, an output unit 77, a memory unit 78, and a communication unit 79 are connected to the input/output interface 75. The input unit 76 is configured of a keyboard, a mouse, and so forth. The output unit 77 is configured of a display such as a CRT (Cathode Ray Tube), an LCD, an organic EL panel, or the like, a speaker, and so forth. The memory unit 78 is configured of a hard disk and so forth. The communication unit 79 is configured of a modem and so forth. The communication unit 79 carries out communication processing through a network including the internet.

A drive 80 is also connected to the input/output interface 75 as appropriate. A removable medium 81 such as a magnetic disk, an optical disk, a magnet optical disk, or a semiconductor memory is mounted to the drive 80 as appropriate, and a computer program read out therefrom is installed onto the memory unit 78 as appropriate.

In a case where the above-described panoramic combining processing is carried out by software, a program that constitutes the software is installed from a network or a recording medium.

This recording medium, for example, is configured of the removable medium 81 that is configured of a magnet disk (including a flexible disk), an optical disk (including a Blu-ray Disc (R)), a CD-ROM (Compact Disc-Read Only Memory), and a DVD (Digital Versatile Disc), a magnet optical disk (including Mini Disc), or a semiconductor memory that is distributed, separately from the device body, to deliver the program to a user and that has the program recorded thereon, as shown in FIG. 21. Alternatively, the recording medium is configured of the ROM 72, a hard disk included in the memory unit 78, or the like that is distributed to be user being embedded in the device body in advance and that has the program recorded thereon.

With such computing device 70, when n pieces of frame image data FM#0 to FM#(n−1) for panoramic image generation are inputted through a receiving operation by the communication unit 79 or a playback operation in the drive 80 (the removable medium 81) or the memory unit 78, the CPU 71 realizes the function of FIG. 5 or FIG. 15 based on the program and executes the above-described panoramic combining processing.

Through this, a single piece of panoramic image data is generated from the inputted n pieces of frame image data FM#0 to FM#(n−1).

### <10. Modification>

Thus far, the embodiment has been described, but various modifications on the image processing device according to the embodiment of the present disclosure can be considered.

It is advantageous to install the image processing device according to the embodiment of the present disclosure in, aside from the above-described image capturing apparatus 1 and the computing device 70, a mobile phone, a game console, and a video device that are equipped with an image capturing function, a mobile phone, a game console, a video device, and an information processing device that do not have an image capturing function but have a function to input frame image data.

For example, in the case of a device that does not have an image capturing function, by carrying out the processing as in FIG. 16, FIG. 17, or FIG. 20 on a series of inputted frame image data, the panoramic combining processing that yields the aforementioned effects can be realized.

Further, in a device in which frame image data are inputted together with the object information, at least the moving object detection processing 202 does not need to be carried out.

That is, when the image processing device of the embodiment of the present disclosure is embedded in the image capturing apparatus 1, realized in an information processing device such as the computing device 70, or even realized as a single device, such image processing device includes the seam determination processing unit 21 and the seam reference determination processing unit 24. In addition, the image processing device may further include the image combining unit 22 and the object information detecting unit 20.

Further, in the embodiment, although the seam reference aSM is set as a straight line that is perpendicular to the sweep direction and doing so is advantageous in terms of simplifying the seam reference determination processing, it is contemplated that the seam reference aSM is set as a straight line that is inclined and is not perpendicular to the sweep direction or a non-linear line.

Further, in the description in FIG. 10, the seam SM is in the end an indeterminate shaped line, but it may be set to desirably be a curbed line, or desirably be a polygonal line or a straight line. For example, by setting a polygonal seam SM by joining line segments after reducing sample points for the two-dimensional cost search, the seam determination processing can be simplified.

Additionally, the present technology may also be configured as below.

(1) An image processing device, including:

a seam reference determination processing unit that determines a seam reference to serve as a reference line for determining a seam between adjacent two pieces of frame image data of a series of n pieces (n is a natural number equal to or greater than 2) of frame image data to be used for panoramic image generation using object information of the adjacent two pieces of frame image data; and

a seam determination processing unit that determines a seam between the adjacent two pieces of frame image data only within a determining region that is set based on the seam reference determined by the seam reference determination processing unit using the object information.

(2) The image processing device according to (1),

wherein the seam reference determined by the seam reference determination processing unit serves as a linear reference line that is perpendicular to a sweep direction at image capturing for a series of frame image data.

(3) The image processing device according to (1) or (2),

wherein the seam reference determination processing unit determines the seam reference by optimizing a one-dimensional cost function that reflects the object information.

(4) The image processing device according to any one of (1) to (3),

wherein the seam determination processing unit determines the seam by optimizing a two-dimensional cost function that reflects the object information.

(5) The image processing device according to (4),

wherein the seam is an indeterminate shaped line.

(6) The image processing device according to any one of (1) to (5),

wherein the determining region is a region that, of an overlapping region of adjacent two pieces of frame image data, falls within a predetermined distance from a line serving as the seam reference in a sweep direction at image capturing for a series of frame image data and in an opposite direction thereof, respectively.

(7) The image processing device according to (6),

wherein the predetermined distance to set the determining region is set variably.

(8) The image processing device according to any one of (1) to (7), further including:

an image combining unit that combines each frame image data based on each seam determined by the seam determination processing unit to generate panoramic image data that uses the n pieces of frame image data.

(9) The image processing device according to (8),

wherein the image combining unit carries out blend processing on a range of adjacent two pieces of frame image data that falls within a predetermined distance from a line serving as the seam in a sweep direction at image capturing for a series of frame image data and in an opposite direction thereof, respectively, to combine the two pieces of frame image data.

(10) The image processing device according to any one of (1) to (9),

wherein the object information detecting unit detects object information of frame image data in an input process of a series of n pieces of frame image data to be used in panoramic image generation, and

wherein the seam reference determination processing unit sequentially carries out, in the input process, processing to determine m or less seam references for each group of (m+1) pieces (m<n) of frame image data.

(11) The image processing device according to (10),

wherein the seam determination processing unit carries out processing to determine the each seam within a determining region that is set based on each determined seam reference each time processing to determine the m or less seam references is carried out by the seam reference determination processing unit.

(12) The image processing device according to any one of (1) to (11), further comprising:

an object information detecting unit that detects object information of a series of n pieces of frame image data to be used in panoramic image generation.

(13) The image processing device according to any one of (1) to (12),

wherein the seam reference determination processing unit determines the seam reference using image data of a first resolution, and

the seam determination processing unit determines the seam using image data that are higher in resolution than the image data of the first resolution.

(14) The image processing device according to (12),

wherein the object information detecting unit includes a low resolution object information detecting unit that detects object information of low resolution image data and a high resolution object information detecting unit that detects object information of high resolution image data,

wherein the seam reference determination processing unit determine the seam reference, with respect to frame image data, using object information obtained by the low resolution object information detecting unit, and

the seam determination processing unit determines the seam, with respect to at least an image within the determining region of frame image data, using object information obtained by the high resolution object information detecting unit.

The present disclosure contains subject matter related to that disclosed in Japanese Priority Patent Application JP 2012-100620 filed in the Japan Patent Office on Apr. 26, 2012, the entire content of which is hereby incorporated by reference.

What is claimed is:

1. An image processing device, comprising:
a seam reference determination processing unit that determines a seam reference to serve as a reference line for determining a seam between adjacent two pieces of frame image data of a series of n pieces (n is a natural number equal to or greater than 2) of frame image data to be used for panoramic image generation using object information of the adjacent two pieces of frame image data; and
a seam determination processing unit that determines a seam between the adjacent two pieces of frame image data only within a determining region that is set based on the seam reference determined by the seam reference determination processing unit using the object information.

2. The image processing device according to claim 1,
wherein the seam reference determined by the seam reference determination processing unit serves as a linear reference line that is perpendicular to a sweep direction at image capturing for a series of frame image data.

3. The image processing device according to claim 1,
wherein the seam reference determination processing unit determines the seam reference by optimizing a one-dimensional cost function that reflects the object information.

4. The image processing device according to claim 1,
wherein the seam determination processing unit determines the seam by optimizing a two-dimensional cost function that reflects the object information.

5. The image processing device according to claim 4,
wherein the seam is an indeterminate shaped line.

6. The image processing device according to claim 1,
wherein the determining region is a region that, of an overlapping region of adjacent two pieces of frame image data, falls within a predetermined distance from a line serving as the seam reference in a sweep direction at image capturing for a series of frame image data and in an opposite direction thereof, respectively.

7. The image processing device according to claim 6,
wherein the predetermined distance to set the determining region is set variably.

8. The image processing device according to claim 1, further comprising:
an image combining unit that combines each frame image data based on each seam determined by the seam determination processing unit to generate panoramic image data that uses the n pieces of frame image data.

9. The image processing device according to claim 8,
wherein the image combining unit carries out blend processing on a range of adjacent two pieces of frame image data that falls within a predetermined distance from a line serving as the seam in a sweep direction at image capturing for a series of frame image data and in an opposite direction thereof, respectively, to combine the two pieces of frame image data.

10. The image processing device according to claim 1,
wherein the object information detecting unit detects object information of frame image data in an input process of a series of n pieces of frame image data to be used in panoramic image generation, and
wherein the seam reference determination processing unit sequentially carries out, in the input process, processing to determine m or less seam references for each group of (m+1) pieces (m<n) of frame image data.

11. The image processing device according to claim 10,
wherein the seam determination processing unit carries out processing to determine the each seam within a determining region that is set based on each determined seam reference each time processing to determine the m or less seam references is carried out by the seam reference determination processing unit.

12. The image processing device according to claim 1, further comprising:
an object information detecting unit that detects object information of a series of n pieces of frame image data to be used in panoramic image generation.

13. The image processing device according to claim 1,
wherein the seam reference determination processing unit determines the seam reference using image data of a first resolution, and
the seam determination processing unit determines the seam using image data that are higher in resolution than the image data of the first resolution.

14. The image processing device according to claim 12,
wherein the object information detecting unit includes a low resolution object information detecting unit that detects object information of low resolution image data and a high resolution object information detecting unit that detects object information of high resolution image data,
wherein the seam reference determination processing unit determine the seam reference, with respect to frame image data, using object information obtained by the low resolution object information detecting unit, and
the seam determination processing unit determines the seam, with respect to at least an image within the determining region of frame image data, using object information obtained by the high resolution object information detecting unit.

15. An image processing method, comprising:
seam reference determination processing that determines a seam reference to serve as a reference line for determining a seam between adjacent two pieces of frame image data of a series of n pieces (n is a natural number equal to or greater than 2) of frame image data to be used for panoramic image generation using object information of the adjacent two pieces of frame image data; and
seam determination processing that determines a seam between the adjacent two pieces of frame image data only within a determining region that is set based on the seam reference determined in the seam reference determination processing using the object information.

16. A program to cause an arithmetic processing device to execute:
seam reference determination processing that determines a seam reference to serve as a reference line for determining a seam between adjacent two pieces of frame image data of a series of n pieces (n is a natural number equal to or greater than 2) of frame image data to be used for panoramic image generation using object information of the adjacent two pieces of frame image data; and
seam determination processing that determines a seam between the adjacent two pieces of frame image data only within a determining region that is set based on the seam reference determined in the seam reference determination processing using the object information.
